(19) United States
(12) Patent Application Publication
(10) Pub. No.: US 2016/0112944 A1
(43) Pub. Date: Apr. 21, 2016

(54) ACCESS POINT SELECTION BASED ON ASSOCIATION PERFORMANCE

(71) Applicant: QUALCOMM Incorporated, San Diego, CA (US)

(72) Inventors: Yan Zhou, San Diego, CA (US); George Cherian, San Diego, CA (US)

(21) Appl. No.: 14/884,696

(22) Filed: Oct. 15, 2015

Related U.S. Application Data
(60) Provisional application No. 62/139,299, filed on Mar. 27, 2015.
(60) Provisional application No. 62/065,323, filed on Oct. 17, 2014.

(51) Int. Cl. H04W 48/20; H04W 48/16; H04W 12/06

(52) U.S. Cl. CPC H04W 48/20; H04W 12/06; H04W 48/16; H04W 84/12

(57) ABSTRACT

Methods, systems, and devices are described for wireless communication at a wireless device, and for selecting or coordinating with an access point (AP) based on association performance of access points. A wireless device under the coverage of more than one AP can associate with one or more APs to establish communication with a network. A wireless device may estimate a delay due to authentication with an AP, and the wireless device may communicate with another AP while waiting to be authenticated. In some examples, a wireless device may associate with an AP despite sub-optimal access metrics; this may involve certain permissions from the AP. In other examples, an AP may manage pre-association devices, post-association devices, or both, based on certain priorities. A mobile device may request and/or receive information regarding association delays and/or channel load metrics from one or several APs and may select an AP accordingly.

### CROSS REFERENCES

The present application for patent claims priority to U.S. Provisional Patent Application No. 62/139,299 by Zhou et al., entitled “Access Point Selection Based on Association Performance,” filed Mar. 27, 2015, and U.S. Provisional Patent Application No. 62/065,323, by Zhou et al., entitled “Access Point Selection Based on Association Performance,” filed Oct. 17, 2014 and assigned to the assignee hereof, with each expressly incorporated by reference herein.

### BACKGROUND

The following relates generally to wireless communication, and more specifically to selecting an access point based on association performance.

Wireless communication systems are widely deployed to provide various types of communication content such as voice, video, packet data, messaging, broadcast, and so on. These systems may be multiple-access systems capable of supporting communication with multiple users by sharing the available system resources (e.g., time, frequency, and power).

A wireless network, for example a wireless local area network (WLAN), such as a network operating according to one of the IEEE 802.11 family of standards (“Wi-Fi”) may include an access point (AP) that may communicate with one or more stations (STAs) or mobile devices. The AP may be coupled to a network, such as the Internet, and may enable a mobile device to communicate via the network, and/or to communicate with other devices coupled to the AP. A wireless device may communicate with a network device bi-directionally with an AP upon establishing a connection and associating with the AP. A mobile device may, in some cases, select an AP for association, and the selected AP may require more time to associate the selected AP than other APs with which the mobile device could communicate. In some cases, an association delay may also result in an efficient use of resources (e.g., time) that mobile device could otherwise utilize. Certain APs may also have a number of associated APs that do not fully use available resources (e.g., bandwidth).

### SUMMARY

Systems, methods, and apparatuses for selecting or coordinating with an access point based on association performance are described. A wireless device may be within the coverage area of more than one AP, and so the wireless device may therefore select one or more APs to associate with and thus for communication with a network. One or several APs may provide association delay metrics to the wireless device in order to assist the wireless device in selecting an AP that may have preferred association performance (e.g., low association delay). In some examples, an AP may be configured to reach multiple service providers. As a result, the AP may transmit association delay metrics to the mobile device for each of the plurality of service providers associated with the AP. Additionally or alternatively, the AP may transmit association delay metrics associated with a neighboring AP or neighboring APs. Thus, in accordance with the present disclosure, a mobile device may receive an association delay metric or a channel load metric, or both, for a plurality of APs, and it may select an AP for association based in part on the received metrics.

A method of wireless communication is described. The method may include receiving an association delay metric from at least one access point of a plurality of APs, and selecting an AP of the plurality of APs for association based at least in part on the received association delay metric.

An apparatus for wireless communication is described. The apparatus may include an association delay component for receiving an association delay metric from at least one AP of a plurality of APs, and a communication establishment component for selecting an AP of the plurality of APs for association based at least in part on the received association delay metric.

A further apparatus for wireless communication is described. The apparatus may include a processor, memory in electronic communication with the processor, and instructions stored in the memory. The instructions may be executable by the processor to receive an association delay metric from at least one AP of a plurality of APs, and select an AP of the plurality of APs for association based at least in part on the received association delay metric.

A non-transitory computer-readable medium storing code for wireless communication is described. The code may include instructions executable to receive an association delay metric from at least one AP of a plurality of APs, and select an AP of the plurality of APs for association based at least in part on the received association delay metric.

Some examples of the method, apparatuses, and/or non-transitory computer-readable medium described above may further include features of or instructions for identifying the association delay metric based on an authentication type. Additionally or alternatively, in some examples the association delay metric corresponds with a plurality of authentication types, the authentication types comprising at least one of Extensible Authentication Protocol (EAP) or EAP Re-authentication Protocol (EAP-RP).

Some examples of the method, apparatuses, and/or non-transitory computer-readable medium described above may further include features of or instructions for receiving, from the AP, an association delay metric for at least one neighbor AP of the plurality of APs. The association delay metrics may also correspond with a plurality of service provider networks. Additionally or alternatively, in some examples, the association delay metric includes at least one of a round-trip-delay (RTD) statistic between the AP and a network server or a RTD statistic between a station and a network server, or association failure rate, or combination thereof.

In some examples of the method, apparatuses, and/or non-transitory computer-readable medium described above, selecting the AP of the plurality of APs comprises determining that the association delay metric satisfies at least one QoS requirement of a mobile device. Additionally or alternatively, in some examples, selecting the AP of the plurality of APs is based on a response time for a measurement message between a mobile device and a network server. In some examples, the association delay metric is based on a response time for a measurement message between the AP and a network server.

An additional method of wireless communication is described. The method may include calculating a first association delay metric for a first AP, and transmitting a message comprising the first association delay metric to a mobile device.

In some examples of the method, apparatuses, and/or non-transitory computer-readable medium described above, each may further comprise receiving a second association delay metric for a neighbor AP, and transmitting the second association delay metric. Additionally or alternatively, in some examples, the first association delay metric comprises at least one of a round-trip-delay (RTD) statistic between the AP and a network server or a RTD statistic between a station and a network server, or association failure rate, or combination thereof.

A further apparatus for wireless communication is described. The apparatus may include a delay determination component for calculating a first association delay metric for a first AP, and an association delay communication component for transmitting a message including the first association delay metric to a mobile device.

A further apparatus for wireless communication at a AP is described. The apparatus may include a processor, memory in electronic communication with the processor, and instructions stored in the memory. The instructions may be executable by the processor to calculate a first association delay metric for a first AP, and transmit a message comprising the first association delay metric to a mobile device.

A non-transitory computer-readable medium storing code for wireless communication is described. The code may include instructions executable to calculate a first association delay metric for a first AP, and transmit a message including the first association delay metric to a mobile device.

Some examples of the method, apparatuses, and/or non-transitory computer-readable medium described above may further include features of or instructions for receiving a second association delay metric for a neighbor AP and transmitting the second association delay metric to the mobile device. In some examples the first association delay metric may comprise at least one of a RTD statistic between the AP and a network server of a RTD statistic between a station and a network server, or association failure rate, or combination thereof.

In another method of wireless communication, the method may include transmitting a first message comprising an association metric threshold to an access point, and receiving, in response to the first message, a second message from the AP when the association delay metric of the AP satisfies the threshold. In some examples, the mobile device may establish communication with the AP based in part on receiving the second message.

Some examples of the method, apparatuses, and/or non-transitory computer-readable medium described above may include that the association metric threshold includes limits on at least one of a round trip delay (RTD) statistic between the AP and a network server, or a RTD statistic between a station and a network server, or an association failure rate, or combination thereof. Additionally or alternatively, is some examples, an association metric threshold associated with the first message is added to fast initial link setup (FILS) request parameter. Additionally or alternatively, in some examples, the first message further identifies an authentication type and service provider network. Additionally or alternatively, is some examples, the first message is a probe request message and the second message is a probe response message.

An additional apparatus for wireless communication is described. The apparatus may include a processor, memory in electronic communication with the processor, and instructions stored in the memory. The instructions may be executable by the processor to transmit a first message comprising an association metric threshold to an access point, and receive, in response to the first message, a second message from the AP when the association delay metric of the AP satisfies the threshold. In some examples, the mobile device may establish communication with the AP based in part on receiving the second message.

A further non-transitory computer-readable medium storing code for wireless communication is described. The code may include instructions executable to transmit a first message comprising an association metric threshold to an access point, and receive, in response to the first message, a second message from the AP when the association delay metric of the AP satisfies the threshold. In some examples, the mobile device may establish communication with the AP based in part on receiving the second message.

In some examples of the method, apparatuses, and/or non-transitory computer-readable medium described above, the association metric threshold may include limits on at least one of a RTD statistic between the AP and a network server, or a RTD statistic between a station and a network server, or an association failure rate, or combination thereof. In some examples, the association metric threshold association with the first message may be added to fast initial link setup (FILS) request parameter. In other examples, the first message may further identify authentication type and service provider network. In yet further examples, the first message is a probe request message and the second message is a probe response message.

In yet a further illustrated example, a method of wireless communication is disclosed. The method may include receiving a first message comprising an association metric threshold from a mobile device and determining that an association delay metric for an AP satisfies the received association metric threshold. In some examples, the AP may transmit a second message to the mobile device based on the determining.

In some examples of the method, apparatuses, and/or non-transitory computer-readable medium described above, the first message is a probe request message and the second message is a probe response message. Additionally or alternatively, in some examples, the association metric threshold comprises at least one of a RTD statistic between the AP and a network server or a RTD statistic between a station and a network server, or association failure rate, or combination thereof.

An apparatus for wireless communication is also described. The apparatus may include a processor, memory in electronic communication with the processor, and instructions stored in the memory. The instructions may be executable by the processor to receive a first message comprising an association metric threshold from a mobile device and determine that an association delay metric for an AP satisfies the received association metric threshold. In some examples, the AP may transmit a second message to the mobile device based on the determining.

A further non-transitory computer-readable medium storing code for wireless communication is described. The code may include instructions executable to receive a first message comprising an association metric threshold from a mobile device and determine that an association delay metric for an AP satisfies the received association metric threshold. In some examples, the AP may transmit a second message to the mobile device based on the determining.

In some examples of the method, apparatuses, and/or non-transitory computer-readable medium described above, the first message is a probe request and the second message is a probe response. In yet another example, the association metric threshold may comprise at least one of a RTD statistic between the AP and a network server or a RTD statistic between a station and a network server, or association failure rate, or combination thereof.

A further method of wireless communication is described. The method may include determining a threshold for at least one channel load metric and transmitting a first message comprising the threshold to an access point. The method may further include receiving a second message from the AP when the channel load metric of the AP satisfies the threshold.

In some examples of the method, apparatuses, and/or non-transitory computer-readable medium described above, the threshold limit identifies a maximum number of mobile devices associated with the AP. In some examples, the first message comprises a probe request and the second message comprises a probe response. In some examples, the threshold associated with the first message is added to fast initial link setup (FILS) request parameters.

An apparatus for wireless communication is also described. The apparatus may include a processor, memory in electronic communication with the processor, and instructions stored in the memory. The instructions may be executable by the processor to determine a threshold for at least one channel load metric and transmit a first message comprising the threshold to an access point. The instruction may further be executable by the processor to receive a second message from the AP when the channel load metric of the AP satisfies the threshold.

In some examples of the method, apparatuses, and/or non-transitory computer-readable medium described above, the threshold limit may identify a maximum number of mobile devices associated with the AP. The first message may comprise a probe request and the second message may comprise a probe response. In one example, the threshold associated with the first message may be added to fast initial link setup (FILS) request parameters.

A further method of wireless communication is also described. The method may include receiving a first message comprising a channel metric threshold from a mobile device and determining that channel load metric for an access point may satisfy the received channel metric threshold. In some examples, the second message may be transmitted to the mobile device based on the determining.

In some examples of the method, apparatuses, and/or non-transitory computer-readable medium described above, the channel metric threshold identifies a maximum number of mobile devices associated with the AP. In some examples, the first message is a probe request message and the second message is a probe response message.

An additional apparatus for wireless communication is described. The apparatus may include a processor, memory in electronic communication with the processor, and instructions stored in the memory. The instructions may be executable by the processor to receive a first message comprising a channel metric threshold from a mobile device and determine that channel load metric for an access point may satisfy the received channel metric threshold. In some examples, the second message may be transmitted to the mobile device based on the determining.

A further non-transitory computer-readable medium storing code for wireless communication is described. The code may include instructions executable to receive a first message comprising a channel metric threshold from a mobile device and determine that channel load metric for an access point may satisfy the received channel metric threshold. In some examples, the second message may be transmitted to the mobile device based on the determining.

In some examples of the method, apparatuses, and/or non-transitory computer-readable medium described above, the channel metric threshold identifies a maximum number of mobile devices that may be associated with the AP. In some examples the first message may be a probe request message and the second message is a probe response message.

In other examples, a wireless device may transmit an authorization request message to a target access point, and the wireless device may receive a delay estimation message from the target AP in response to the authorization request message. The wireless device may thus determine an estimated delay period based on information provided by the delay estimation message. The wireless device may, in some examples, receive a signal including an access metric from each of a set of neighbor APs. The wireless device may determine that each of the received access metrics fails to meet an access threshold for each of the neighbor APs, and the wireless device may transmit a message to one of the neighbor APs indicating that none of the neighbor APs' access metrics meet an access threshold.

In other examples, an AP may identify a time duration for contention based access to the AP, and the AP may transmit a link setup message, which may include a set of access priority parameters, to manage access to the AP during the identified time duration. In some cases, the AP may identify a set of pre-association devices contending for access. The AP may thus transmit a link setup message, including a set of access priority parameters, to manage access by the set of pre-associate devices.

A method of wireless communication is described. The method may include transmitting an authorization request message to a target AP, receiving a delay estimation message from the target AP in response to the authorization request message, and determining an estimated delay period based at least in part on information provided by the delay estimation message.

An apparatus for wireless communication is described. The apparatus may include an authorization request message component for transmitting an authorization request message to a target AP, a delay estimation message component for receiving a delay estimation message from the target AP in response to the authorization request message, and a delay estimator component for determining an estimated delay period based at least in part on information provided by the delay estimation message.

A further apparatus for wireless communication is described. The apparatus may include a processor, memory in electronic communication with the processor, and instructions stored in the memory and operable, when executed by the processor, to cause the processor to transmit an authorization request message to a target AP, receive a delay estimation message from the target AP in response to the authorization request message, and determine an estimated delay period based at least in part on information provided by the delay estimation message.

A non-transitory computer-readable medium storing code for wireless communication is described. The code may include instructions executable to transmit an authorization request message to a target AP, receive a delay estimation message from the target AP in response to the authorization request message, and determine an estimated delay period based at least in part on information provided by the delay estimation message.

Some examples of the method, apparatuses, or non-transitory computer-readable medium described herein may further include processes, features, means, or instructions for transmitting a delay timing message comprising the estimated delay period to a source AP, and resuming traffic communication with the source AP during the estimated delay period. Additionally or alternatively, some examples may include processes, features, means, or instructions for determining that the estimated delay period exceeds a delay threshold, wherein the delay timing message is transmitted and the traffic communication resumed based at least in part on the estimated delay period exceeding the delay threshold.

Some examples of the method, apparatuses, or non-transitory computer-readable medium described herein may further include processes, features, means, or instructions for transmitting a notification message to the source AP after determining that the estimated delay period exceeds the delay threshold, and tuning to the target AP after transmitting the notification message or receipt of an acknowledgment of the notification message by the source AP. Additionally or alternatively, some examples may include processes, features, means, or instructions for tuning to the target AP after the estimated delay period, and receiving an authentication response message from the target AP.

Some examples of the method, apparatuses, or non-transitory computer-readable medium described herein may further include processes, features, means, or instructions for transmitting a polling message to the target AP after tuning to the target AP, and receiving the authentication response message in response to the polling message. Additionally or alternatively, in some examples the delay estimation message is associated with at least one of an authentication server delay, a dynamic host configuration protocol (DHCP) server, a domain name system (DNS) server, or a gateway, or any combination thereof.

In some examples of the method, apparatuses, or non-transitory computer-readable medium described herein, the delay estimation message is associated with a delay estimated by the target AP based at least in part on a round-trip time of a previous message exchange.

A further method of wireless communication is described. The method may include receiving a signal comprising an access metric from each of a plurality of neighbor APs, determining that at least one of the received access metrics fails to meet an access threshold for at least one of the neighbor APs, and transmitting an indication message to at least one of the neighbor APs that at least one of the access metrics fails to meet the access threshold for at least one of the neighbor APs.

A further apparatus for wireless communication is described. The apparatus may include an access metric component for receiving a signal comprising an access metric from each of a plurality of neighbor APs, an access threshold component for determining that at least one of the received access metrics fails to meet an access threshold for at least one of the neighbor APs, and an indication message component for transmitting an indication message to at least one of the neighbor APs that at least one of the access metrics fails to meet the access threshold for at least one of the neighbor APs.

A further apparatus for wireless communication is described. The apparatus may include a processor, memory in electronic communication with the processor, and instructions stored in the memory and operable, when executed by the processor, to cause the processor to receive a signal comprising an access metric from each of a plurality of neighbor APs, determine that at least one of the received access metrics fails to meet an access threshold for at least one of the neighbor APs, and transmit an indication message to at least one of the neighbor APs that at least one of the access metrics fails to meet the access threshold for at least one of the neighbor APs.

A further non-transitory computer-readable medium storing code for wireless communication is described. The code may include instructions executable to receive a signal comprising an access metric from each of a plurality of neighbor APs, determine that at least one of the received access metrics fails to meet an access threshold for at least one of the neighbor APs, and transmit an indication message to at least one of the neighbor APs that at least one of the access metrics fails to meet the access threshold for at least one of the neighbor APs.

Some examples of the method, apparatuses, or non-transitory computer-readable medium described herein may further include processes, features, means, or instructions for receiving a responsive message from at least one of the neighbor APs in response to the indication message, and associating with the at least one neighbor AP based at least in part on receiving the responsive message. Additionally or alternatively, in some examples the access metric comprises at least one of a received signal strength indication (RSSI) or a supported modulation and coding scheme (MCS).

In some examples of the method, apparatuses, or non-transitory computer-readable medium described herein, the access threshold comprises at least one of an RSSI threshold or a maximum supported modulation and MCS threshold. Additionally or alternatively, in some examples the indication message is transmitted in at least one of a probe, an authentication request, an association request, or any combination thereof.

In some examples of the method, apparatuses, or non-transitory computer-readable medium described herein, the indication message comprises a required resource use value comprising at least one of a required air time usage parameter, a required time-frequency resource usage parameter, a required throughput parameter, or any combination thereof. Additionally or alternatively, in some examples a responsive message received from at least one of the neighbor APs is responsive to the required resource use value and comprises at least one of an access denial or a suggested resource use, or both.

In some examples of the method, apparatuses, or non-transitory computer-readable medium described herein, the indication message comprises a traffic type value indicative of a least one of a no traffic type, a with traffic type, a real-time traffic type, or a non-real-time traffic type, or any combination thereof. Additionally or alternatively, in some examples a responsive message received from at least one of the neighbor APs is responsive to the traffic type value.

In some examples of the method, apparatuses, or non-transitory computer-readable medium described herein, the indication message comprises a network availability value indicative of whether a device may fall back to a network exclusive of at least one of the neighbor APs receiving the indication message. Additionally or alternatively, in some examples a responsive message received from at least one of the neighbor APs is responsive to the network availability value.

A further method of wireless communication is described. The method may include identifying a time duration for contention based access to an access AP, and transmitting a link setup message comprising a plurality of access priority parameters to manage access by a first set of wireless devices to the AP during the identified time duration.

A further apparatus for wireless communication is described. The apparatus may include a duration identification component for identifying a time duration for contention based access to an access AP, and a link setup message component for transmitting a link setup message comprising a plurality of access priority parameters to manage access by a first set of wireless devices to the AP during the identified time duration.

A further apparatus for wireless communication is described. The apparatus may include a processor, memory in electronic communication with the processor, and instructions stored in the memory and operable, when executed by the processor, to cause the processor to identify a time duration for contention based access to an access AP, and transmit a link setup message comprising a plurality of access priority parameters to manage access by a first set of wireless devices to the AP during the identified time duration.

A further non-transitory computer-readable medium storing code for wireless communication is described. The code may include instructions executable to identify a time duration for contention based access to an access AP, and transmit a link setup message comprising a plurality of access priority parameters to manage access by a first set of wireless devices to the AP during the identified time duration.

In some examples of the method, apparatuses, or non-transitory computer-readable medium described herein, the wireless devices of the first set comprise pre-association devices of the AP. Additionally or alternatively, some examples may include processes, features, means, or instructions for selecting values for the access priority parameters based at least in part on an association priority from a second set of pre-association devices of the AP during the identified time duration, wherein the second set of pre-association devices has a higher association priority than the first set of pre-association devices.

In some examples of the method, apparatuses, or non-transitory computer-readable medium described herein, the access priority parameters comprise at least an enhanced distributed channel access (EDCA) parameter, an energy detection (ED) threshold parameter, a packet detection (PD) threshold parameter, or a transmit power lower or upper limit parameter, or a combination thereof. Additionally or alternatively, in some examples the enhanced distributed channel access (EDCA) parameter comprises an exact value, an index corresponding to an access category of a pre-association device, or a combination thereof.

In some examples of the method, apparatuses, or non-transitory computer-readable medium described herein, the access priority parameters comprise a plurality of ED threshold parameters, and each ED threshold parameter corresponds to a different sub-channel. Additionally or alternatively, in some examples the plurality of access priority parameters comprises subsets of access priority parameters, and each subset of access priority parameters corresponds to a classification for each pre-association device of the first set of wireless devices.

In some examples of the method, apparatuses, or non-transitory computer-readable medium described herein, the classification comprises a pre-association device with traffic or a pre-association device without traffic, or both. Additionally or alternatively, in some examples the classification comprises at least a pre-association device with real-time traffic, a pre-association device with non-real-time traffic, or a pre-association device with no traffic, or a combination thereof.

In some examples of the method, apparatuses, or non-transitory computer-readable medium described herein, the wireless devices of the first set comprise post-association devices of the AP. Additionally or alternatively, some examples may include processes, features, means, or instructions for selecting values for the access priority parameters based at least in part on a medium usage by the post-association devices, a medium usage by a set of pre-association devices, or an access category of the at least one post-association device, or any combination thereof.

In some examples of the method, apparatuses, or non-transitory computer-readable medium described herein, the access priority parameters comprise at least an enhanced distributed channel access (EDCA) parameter, an energy detection (ED) threshold parameter, a packet detection (PD) threshold parameter, or a transmit power lower or upper limit parameter, or a combination thereof. Additionally or alternatively, in some examples the access priority parameters comprise a no access indicator.

A further method of wireless communication is described. The method may include identifying a set of pre-association devices contending for access to an AP, and transmitting a link setup message comprising a plurality of access priority parameters to manage access by the set of pre-associate devices.

A further apparatus for wireless communication is described. The apparatus may include a device identification component for identifying a set of pre-association devices contending for access to an AP, and a link setup message component for transmitting a link setup message comprising a plurality of access priority parameters to manage access by the set of pre-associate devices.

A further apparatus for wireless communication is described. The apparatus may include a processor, memory in electronic communication with the processor, and instructions stored in the memory and operable, when executed by the processor, to cause the processor to identify a set of pre-association devices contending for access to an AP, and transmit a link setup message comprising a plurality of access priority parameters to manage access by the set of pre-associate devices.

A further non-transitory computer-readable medium storing code for wireless communication is described. The code may include instructions executable to identify a set of pre-association devices contending for access to an AP, and transmit a link setup message comprising a plurality of access priority parameters to manage access by the set of pre-associate devices.

In some examples of the method, apparatuses, or non-transitory computer-readable medium described herein, the access priority parameters are based at least in part on a classification for each pre-associate device, the classification comprising a wireless device with traffic or a wireless device without traffic, or both. Additionally or alternatively, in some examples the classification comprises at least a wireless device with real-time traffic, or a wireless device with non-real-time traffic, or a wireless device with no traffic, or a combination thereof.

In some examples of the method, apparatuses, or non-transitory computer-readable medium described herein, the link setup message comprises an information element comprising access priority parameters associated with a plurality of classifications.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 illustrates an example of a wireless communication system that supports selecting and coordinating with an access point based on association performance in accordance with various aspects of the present disclosure;

FIG. 2 illustrates an example of a wireless communication system that supports selecting and coordinating with an access point based on association performance in accordance with various aspects of the present disclosure;

FIGS. 3A-3C illustrate an example or examples of a message flow in a system or systems that support selecting and coordinating with an access point based on association performance in accordance with various aspects of the present disclosure;

FIG. 4 illustrates an example of a probe response message for selecting an access point based on association performance in accordance with various aspects of the present disclosure;

FIG. 5A illustrates an example of a fast initial link setup (FILS) request for selecting an access point based on association performance in accordance with various aspects of the present disclosure;

FIG. 5B illustrates example of a differentiated initial link setup (DILS) element that supports selecting and coordinating with an access point in accordance with various aspects of the present disclosure;

FIG. 5C illustrates example of an access parameter set element that supports selecting and coordinating with an access point in accordance with various aspects of the present disclosure;

FIGS. 6A and 6B show block diagrams of a mobile device or devices that support selecting and coordinating with an access point based on association performance in accordance with various aspects of the present disclosure;

FIGS. 7A and 7B show block diagrams of a mobile device or devices that support selecting and coordinating with an access point based on association performance in accordance with various aspects of the present disclosure;

FIGS. 8A and 8B show block diagrams of an access point selection component and an association coordination component that support selecting and coordinating with an access point based on association performance in accordance with various aspects of the present disclosure;

FIG. 9 illustrates a block diagram of a wireless communication system that supports selecting and coordinating with an access point based on association performance in accordance with various aspects of the present disclosure;

FIGS. 10A and 10B show block diagrams of an access point (AP) or APs that support selecting and coordinating with an access point based on association performance in accordance with various aspects of the present disclosure;

FIGS. 11A and 11B show block diagrams of an AP or APs that support selecting and coordinating with an access point based on association performance in accordance with various aspects of the present disclosure;

FIGS. 12A and 12B show block diagrams of an AP delay determination component and an AP association coordination component that support selecting and coordinating with an access point based on association performance in accordance with various aspects of the present disclosure;

FIG. 13 illustrates a block diagram of a wireless communication system that supports selecting and coordinating with an access point based on association performance in accordance with various aspects of the present disclosure;

FIG. 14 shows a flowchart illustrating a mobile device method for selecting an access point based on association performance in accordance with various aspects of the present disclosure;

FIG. 15 shows a flowchart illustrating a mobile device method for selecting an access point based on association performance in accordance with various aspects of the present disclosure;

FIG. 16 shows a flowchart illustrating an AP method for selecting an access point based on association performance in accordance with various aspects of the present disclosure;

FIG. 17 shows a flowchart illustrating an AP method for selecting an access point based on association performance in accordance with various aspects of the present disclosure;

FIG. 18 shows a flowchart illustrating a mobile device method for selecting an access point based on association performance in accordance with various aspects of the present disclosure;

FIG. 19 shows a flowchart illustrating an AP method for selecting an access point based on association performance in accordance with various aspects of the present disclosure.

FIG. 20 shows a flowchart illustrating a mobile device method for selecting an access point based on association performance in accordance with various aspects of the present disclosure;

FIG. 21 shows a flowchart illustrating an AP method for selecting an access point based on association performance in accordance with various aspects of the present disclosure;

FIG. 22 shows a flowchart illustrating a method for coordinating with an access point based on association performance in accordance with various aspects of the present disclosure;

FIG. 23 shows a flowchart illustrating a method for coordinating with an access point based on association performance in accordance with various aspects of the present disclosure;

FIG. 24 shows a flowchart illustrating a method for coordinating with an access point based on association performance in accordance with various aspects of the present disclosure; and

FIG. 25 shows a flowchart illustrating a method for coordinating with an access point based on association performance in accordance with various aspects of the present disclosure.

### DETAILED DESCRIPTION

A wireless device may be within the coverage areas of several of APs. In such instances, it may be beneficial for the mobile device to consider association performance metrics, including association delay and/or channel load, related to multiple APs, and thus select an AP that may offer a preferred association performance (e.g., reduced association delay, greater throughput, etc.). In some examples, the association delay may be the time required to complete authentication and acquire an IP address from a server. It may be desirable to associate with an AP that has a lower association delay than other available APs.

APs may provide association delay performance metrics to wireless devices within the APs' coverage areas, which may be used by the mobile devices to select one of the APs for association, and thus communication with a network. In some examples, an AP may be configured to reach multiple service provider networks. As a result, the AP may provide association delay metrics to the mobile device for each service provider network associated with the AP. Additionally or alternatively, the AP may determine and transmit association delay metrics for one or more neighbor APs. Based on the received association delay metrics, the mobile device may be better informed to select an AP that satisfies at least one Quality of Service (QoS) requirement of the mobile device, for example.

In other examples of the present disclosure, the mobile device, prior to selecting an AP, may transmit a probe request message to one or more APs. In some examples, the probe request message may include limits (e.g., a threshold) for an association delay metric corresponding to each of the APs, which may be included in a plurality of APs, that may be in range of the mobile device. Thus, the AP, upon receiving the probe request message, may reply to the mobile device if, for instance, the mean RTD between the AP and an authentication server is less than the threshold imposed by the mobile device.

The mobile device may also indicate thresholds and/or limits on the channel load for the AP. For example, the mobile device may identify a maximum value or values for a channel load. Channel load metrics may include, for example, total channel load, channel load due to basic service set (BSS) and/or the number of associated or active mobile devices on a channel between the AP and the mobile device. Thus, in some instances, the AP may determine channel load associated with the AP and reply to the mobile if, for instance, the measured channel load is less than the load limits identified by the mobile device.

The mobile device, by seeking to limit the number of eligible APs to those that satisfy the performance requirements of the mobile device (e.g., association delay metrics and/or channel load metrics), may effectively reduce delay associated with establishing communication with the network. The mobile device may, in some cases, also increase throughput.

In some cases, a differentiated initial link setup (DILS) element may include a field with access parameters that may prioritize access among mobile devices. This prioritization may allow otherwise unallowed mobile devices to contend for access during a DILS time period. An AP may thus identify a time period for contention based access to the AP, and the AP may transmit (e.g., broadcast) a link setup message that includes access priority parameters to manage pre-association mobile devices. Additionally or alternatively, an AP may control access by defining access parameters on a per-device classification basis. For instance, an AP may select values for access priority parameters based on medium usage by pre-association devices or post-association devices, or both. In some examples, traffic categories for pre- or post-association devices may also be considered in selecting access priority parameters.

In other examples, pre-association mobile devices may be delayed in their association because of other, existing traffic at an AP. The AP may thus transmit a link setup message with access priority parameters to those pre-associate devices. The access priority parameters may be based on a traffic classification of the pre-association devices, for instance.

A mobile device may coordinate access to an AP by estimating a delay to authenticate with a new AP (e.g., a target AP). During the estimated delay, the mobile device may continue to utilize resources of an AP with which the device was previously associated (e.g., a source AP). The mobile device may, for instance, transmit an authorization request message to the target AP, and it may receive a delay estimation message in response. Using this delay estimation message, the mobile device may determine an estimated delay period during which the mobile device may resume or maintain communication with the source AP.

In some cases, a mobile device may be unable to associate with a neighbor AP (or any neighbor APs) because of a low received signal strength indication (RSSI) or unsupported modulation and coding scheme (MCS). The AP may thus transmit an indication message to one or several neighbor APs with which the mobile device is unable to associate. The AP or APs receiving the message may then allow the mobile device to associate subject to certain conditions or if certain thresholds are met.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

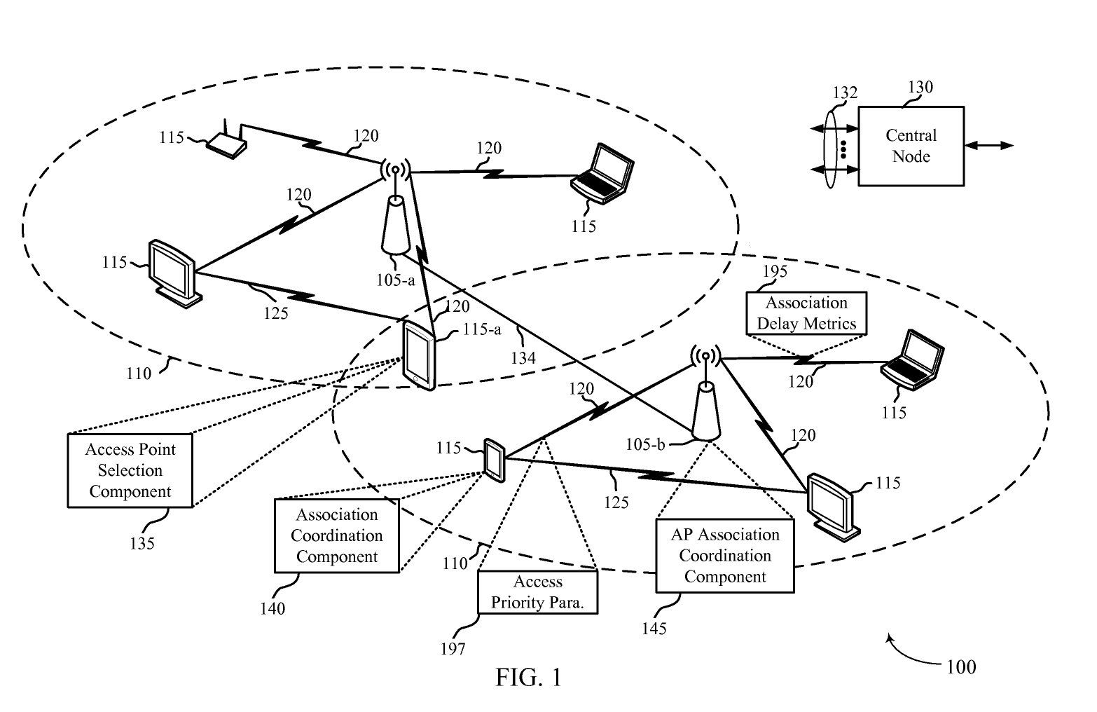

Referring first to FIG. 1, illustrates an example of a wireless communication system 100 for selecting an access point based on association performance in accordance with various aspects of the present disclosure. The wireless communication system 100 may, in some examples, be a WLAN network. The WLAN network may include one or more access points (APs) 105, one or more mobile devices or stations (STAs) 115, and a central node 130 (e.g., a server). While only two APs 105 are illustrated, the WLAN network may have more than two APs 105. Each of the mobile devices 115, which may also be referred to as mobile stations (MSs), stations (STAs), nodes, mobile devices, access terminals (ATs), user equipment (UE), subscriber stations (SSs), or subscriber units, may associate and communicate with an AP 105 via a communication link 120. Each AP 105 has a geographic coverage area 110 such that mobile devices 115 within that area can typically communicate with the AP 105. The mobile devices 115 may be dispersed throughout the geographic coverage area 110. Each mobile device 115 may be stationary or mobile at various times. The APs 105 interface with the central node 130 through backhaul links 132. The APs 105 may operate under the control of the central node 130. In various examples, the APs 105 may communicate, either directly or indirectly (e.g., through the central node 130), with each other over the backhaul links 134, which may be wired or wireless communication links. As used herein, the term “node” may apply to either an AP 105 or a mobile device 115.

While the mobile devices 115 may communicate with each other through the AP 105 using communication links 120, each mobile device 115 may also communicate directly with one or more other mobile devices 115 via a direct wireless link 125. Two or more mobile devices 115 may communicate via a direct wireless link 125 when both mobile devices 115 are in the geographic coverage area 110 or when one or neither mobile device 115 is within the AP geographic coverage area 110. Examples of direct wireless links 125 may include Wi-Fi Direct connections, connections established using a Wi-Fi Tunneled Direct Link Setup (TDLS) link, and other P2P group connections. In other implementations, other peer-to-peer connections and/or ad hoc networks may be implemented within the wireless communication system 100. The mobile devices 115 may be cell phones, smartphones, personal digital assistants (PDAs), other handheld devices, netbooks, notebook computers, tablet computers, laptops, display devices (e.g., TVs, computer monitors, etc.), printers, and the like.

The central node 130 may be a server or a central controller. The central node 130 may connect to the APs 105 in the wireless communication system 100. The central node 130 may be connected to the APs 105 through a wired backhaul, such as through backhaul links 132. Each AP 105 may provide the central node 130 with one or more metrics from the basic service set (BSS) that the AP 105 serves. In some examples, APs 105 may connect with multiple central node(s) 130 (e.g., a plurality of service provider servers).

A single AP 105 and an associated set of STAs or mobile devices 115 may be referred to as a BSS. An extended service set (ESS) may be a set of connected BSSs. A distribution system (DS) may be used to connect APs 105 in an extended service set. A geographic coverage area 110 for an AP 105 may be divided into sectors making up only a portion of the coverage area. The wireless communication system 100 may include APs 105 of different types (e.g., metropolitan area, home network, etc.), with varying sizes of coverage areas and overlapping coverage areas for different technologies. Other mobile devices can also communicate with the AP 105.

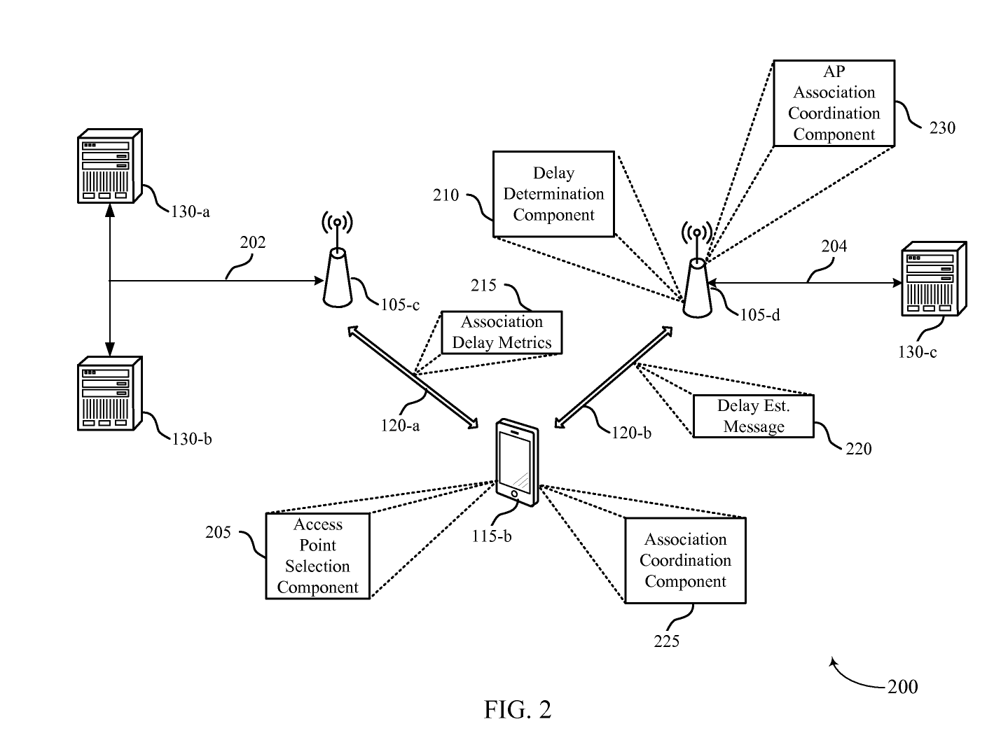

In some examples, one or more mobile devices 115 may include an access point selection component 135. The access point selection component 135 may perform one or more functionalities identified in the present disclosure, including those described with reference to FIGS. 2-5. In some examples, the access point selection component 135 is circuitry configured to perform such functionality. A mobile device 115, such as mobile device 115-a, may be covered by more than one AP 105 and can therefore associate with one or more APs 105. In some cases, however, due to variation in the backhaul speeds associated with each APs 105, for instance, an AP 105 may experience varying association delays with the central node 130. Thus, in some examples, an AP 105 or several APs 105 may provide association delay metrics 195 to the mobile device 115-a to assist the mobile device 115-a in selection of an AP 105 and a central node 130 (e.g., service provider network). In some examples, the association delay may include a time (e.g., 15 ms) to complete authentication and acquire internet protocol (IP) address for the mobile device 115-a. Additionally or alternatively, the association delay metrics 195 may include a round-trip-delay (RTD) statistic between the AP 105 and the central node 130. In other examples, the RTD statistics may be between the mobile device 115-a and the central node 130. The association delay metric 195 may include overall association delay statistics and/or association failure rate for at least one or more APs 105 and/or a plurality of APs 105.

Thus, in accordance with the present disclosure, the access point selection component 135 of the mobile device 115-a may receive an association delay metric or association delay metrics 195 from one AP 105, a plurality of APs 105, or several APs 105, and the mobile device 115-a and select an AP, for example a first AP 105-a, based on determining that the overall association delay for AP 105-a may be lower than the association delay corresponding to a second AP 105-b. Additionally or alternatively, the access point selection component 135 of the mobile device 115-a may transmit a probe request message to one or more APs 105. In some examples, the probe request message may include limits (e.g., thresholds) on an association delay metric or association delay metrics 195 corresponding to each of the APs 105. The AP 105, upon receiving the probe request message, may reply to the mobile device 115-a only if the mean RTD between the AP 105 and an authentication server (e.g., central node 130) is less than the limits imposed by the mobile device 115-a. In some cases, the mobile device 115-a may indicate limits on channel load metrics for the AP 105. The AP 105 may thus reply to the mobile device 115-a only if the measured channel load at the AP 105 is less than the limits indicated by the mobile device 115-a in the probe request message.

In some examples, one or more mobile devices 115 may include an association coordination component 140. The association coordination component 140 may perform functionalities identified in the present disclosure, including those described with reference to FIGS. 2-5C. In some examples, the association coordination component 140 is circuitry configured to perform such functionality. A mobile device 115 may transition from a first AP 105-a to a second AP 105-b. The mobile device 115 may still have traffic on the first AP 105-a while attempting to associate with the second AP 105-b. In order to improve efficiency, the association coordination component 140 may request authorization or association with the second AP 105-b. The second AP 105-b may transmit an estimated delay to the mobile device 115. The association coordination component 140 may use the estimated delay to determine when to expect a response from the second AP 105-b. The association coordination component 140 may instruct the mobile device 115 to continue communicating with the first AP 105-a until it expects to receive a response from the second AP 105-b. The association coordination component 140 may then instruct or cause the mobile device 115 to tune to the second AP 105-b in order to receive the response. Additionally or alternatively, the association coordination component 140 may determine when the mobile device 115 does not meet the requirements of one or more APs 105. The association coordination component 140 may instruct the mobile device 115 to transmit an indication to the second AP 105-b that the mobile device 115 does not meet the requirements of one or more APs 105. The indication may cause the second AP 105-b to accept the mobile device 115, even if the mobile device 115 does not meet all of the requirements of the second AP 105-b.

In some examples, one or more APs 105 may include an AP association coordination component 145. The AP association coordination component 145 may perform functionalities identified in the present disclosure, including those described with reference to FIGS. 2-5C. In some examples, the AP association coordination component 145 is circuitry configured to perform such functionality. An AP 105, such as the second AP 105-b, may associate with a number of mobile devices 115. The AP association coordination component 145 may signal times to associate to groups of mobile devices 115. The AP association coordination component 145 may also indicate an association priority to mobile devices 115 through access priority parameters 197. The AP association coordination component 145 may signal to some groups of mobile devices 115 permission to associate with the second AP 105-b during a time earlier than the mobile devices 115 are scheduled to associate. Additionally or alternatively, the AP association coordination component 145 may reduce or limit traffic of currently associated mobile devices 115 to make it easier for new mobile devices 115 to associate with the second AP 105-b with the access priority parameters 197. Further, the AP association coordination component 145 may signal association priorities to mobile devices 115, or mobile device groups with the access priority parameters 197.

FIG. 2 illustrates an example of a wireless communication system 200 for selecting an access point based on association performance in accordance with various aspects of the present disclosure. Wireless communication system 200 may include a mobile device 115-b, which may be an example of a mobile device 115 described above with reference to FIG. 1. The wireless communication system 200 may also include APs 105-c and 105-d, which may be examples of APs 105 described above with reference to FIG. 1. In some examples, each of the first AP 105-c and the second AP 105-d may be associated with, and connected to, one or more central nodes 130 via communication links 202 and 204. The central nodes 130 may be examples of central node 130 described above with reference to FIG. 1. Central nodes 130 may include, for instance, authentication servers, dynamic host configuration protocol (DHCP) servers, domain name system (DNS) servers, gateways or the like.

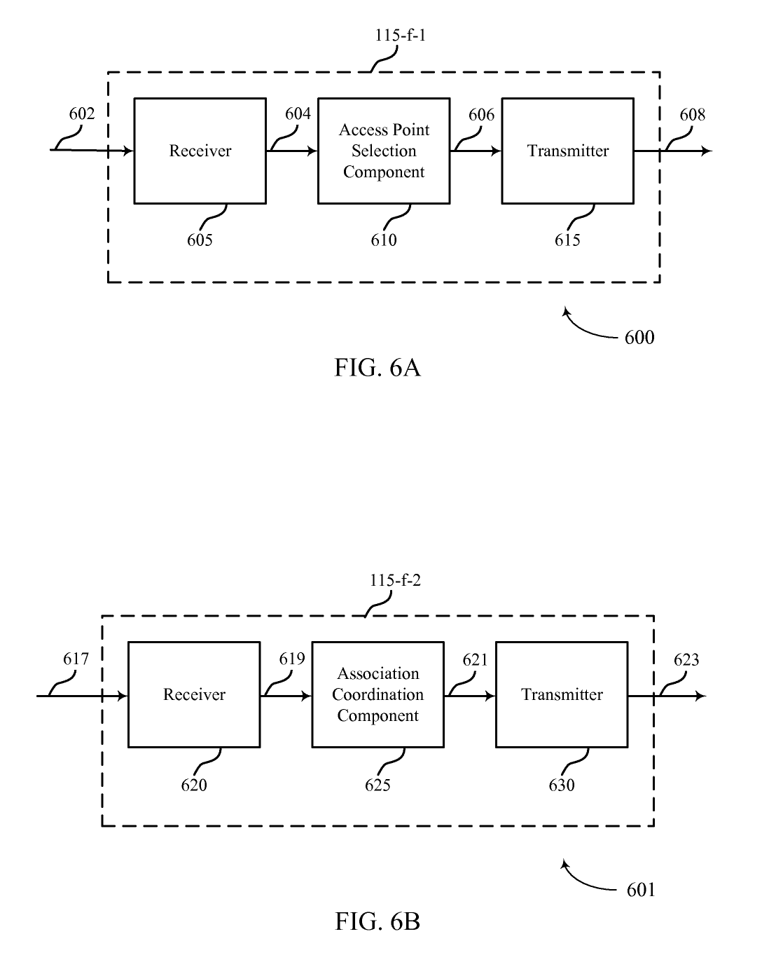

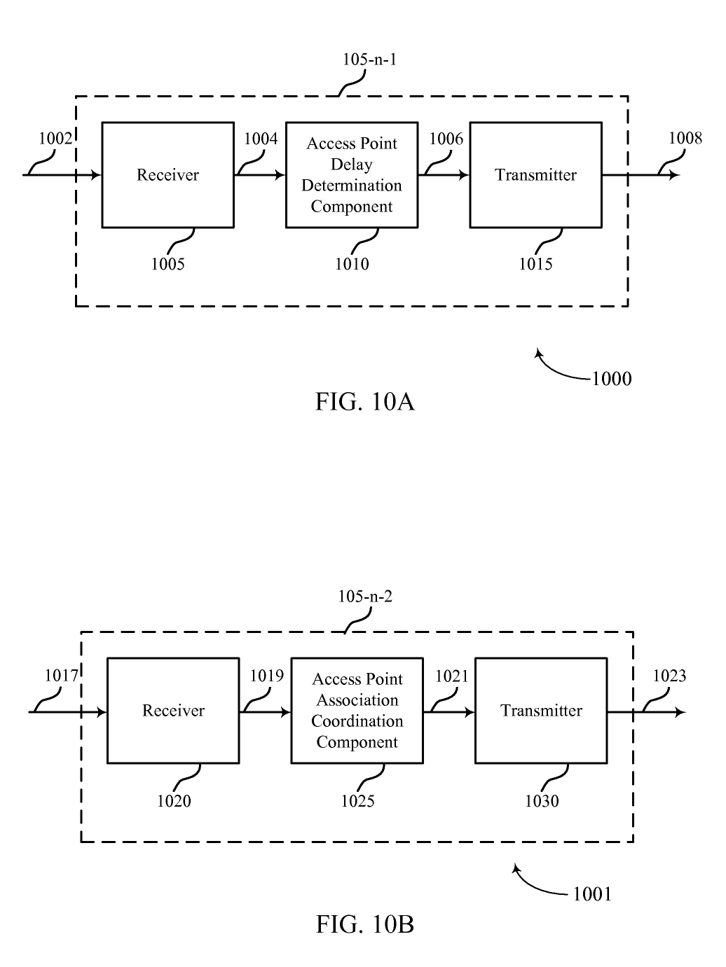

In some examples, mobile device 115-b may include an access point selection component 205 to configured to perform functions described herein, including the functions described with reference to FIGS. 6-9. The access point selection component 205 may be circuitry configured to perform such functions. Additionally or alternatively, one or both APs 105 may include a delay determination component 210 configured to perform the functions described here, including the functions described with reference to FIGS. 10-13. In some examples, the delay determination component 210 is circuitry configured to perform such functions.

The mobile device 115-b may be in a coverage area of both AP 105-c and 105-d. As such, the mobile device 115-b may establish communication with AP 105-c or AP 105-d, or both. In some examples, AP 105-c and/or AP 105-d may each individually provide (e.g., transmit via broadcast or unicast) respective association delay metrics 215 to the mobile device 115-b via communication links 120-a and 120-b; and the mobile device 115-b may employ those association delay metrics to select a preferred AP 105 for association and communication with a network. The association delay metrics may include RTD statistics between an AP 105 and a server or servers. For instance, the association delay metric provided by (e.g., transmitted by) AP 105-c may include statistics for RTD between AP 105-c and central node 130-a and statistics for RTD between AP 105-c and central node 130-b; and the association delay metric provided by AP 105-d may include statistics for RTD between AP 105-d and central node 130-c.

Additionally or alternatively, AP 105-c and AP 105-d may communicate, either directly or indirectly, with each other over backhaul links 134 (FIG. 1), which may be wired or wireless communication links. APs 105 may thus, in some cases, provide to mobile devices 115 associate delay metrics for neighboring APs. For instance, AP 105-c or AP 105-d, or both, may broadcast association delay metrics for themselves and/or for one another. Thus, in accordance with the present disclosure, the first AP 105-c may broadcast to the mobile device 115-c a first set of association delay metrics related to the first AP 105-c and also a second set of association delay metrics related to the second AP 105-d over the communication link 120-a. The mobile device 115-b may therefore be configured to receive multiple association delay metrics from a plurality of APs 105 over a single communication link 120-a, and thus select AP 105-c and/or AP 105-d based on determining which AP 105 offers a lower association delay.

In other examples, mobile device 115-b, prior to receiving any delay metric from an AP 105, may indicate to AP 105-c and/or AP 105-d limits on one or more association delay metrics in the probe request of the mobile device as a criterion for each AP to decide whether to reply with a probe response or not. The limits may be thresholds identifying maximum allowed authentication server RTD, overall association delay, and/or association failure rate. In some examples, the association delay metrics requirements may be further classified based on the intended authentication type (e.g., full EAP, EAP-RP, etc.). The mobile device 115-b may, for example, request association delay metrics for full EAP authentication type when mobile device 115-b is attempting to join an access network. Additionally or alternatively, mobile device 115-b may check metrics for EAP-RP authentication type when transitioning within the network. Because the association delay metrics may depend on the type of intended authentication, mobile device 115-b may specify to APs 105 in the probe request, the intended authentication type and service provider network for each of various limits. The authentication type and service provider network may be identified based on an authentication type code and a network identification (ID). In some examples, mobile device 115-b may specify the limits (e.g., thresholds) using a fast initial link setup (FILS) request parameter element, which can be carried by a probe request.

The AP 105-c and AP 105-d may thus receive the association delay limits from mobile device 115-b, and either or both may determine whether their respective association delay metrics are below the mobile device's 115-b limits. One of the APs 105 may, for example, reply to mobile device 115-b with a probe response message that AP 105 satisfies each of the association delay limits. If only AP 105-c satisfies the association delay limits, only the first AP 105-c may respond to mobile device 115-b with a probe response message. In such cases instance, AP 105-d may refrain from transmitting a probe response message to mobile device 115-b. If both APs 105 satisfy each of the association delay limits, both APs 105 may respond; or one AP 105 may transmit a probe response message on behalf of both APs 105.

In another example, mobile device 115-b may indicate limits on channel load as an AP probe response criterion. The channel load metrics may include total channel load, channel load due to BSS traffic, a number of associated or active mobile devices at an AP, and the like. The mobile device 115-b may identify the channel load limits to each of AP 105-c and AP 105-d using a FILS request parameter element, for example. These limits (e.g., thresholds) may be or include a maximum allowed value per channel load metric. Either AP 105-c or AP 105-d, or both, may reply to mobile device 115-b with a probe response message if the AP's 105 respective metrics satisfy all mobile devices 115-b indicated channel load.

The mobile device 115-b may provide a report to APs 105 to aid the APs 105 in computation of association delay metric. In some examples, mobile device 115-b may have better knowledge of carrier sense multiple access (CSMA) contention start time. So, mobile device 115-b may provide a report to APs 105 that may be used to compute overall association delay statistics in a given time window. The mobile device 115-b may also report to APs 105 a total number of association trials per completed association (e.g., total 3 trials with 2 failed and 1 successful). The APs 105 may use the provided report to compute association failure rate in any given time window.

Association delay metrics computed by APs 105 may be RTD statistics for communication between respective APs 105 and a central node 130, and/or they may include RTD statistics for communication between mobile device 115-b and a server or central nodes 130. The RTD statistics may, for example, include calculated time for over-the-air (OTA) messages between mobile device 115-b and a central node 130. The association delay metrics may also include overall association delay statistics and association failure rate. The overall association delay may be calculated based on an estimated time from mobile device 115-b initiating association with the AP 105 to the time mobile device 115-b completes association with at least one AP 105. In some examples, the association failure rate may be defined as a ratio of total association failure counts to total association trial counts in a predefined time period. Failure may mean that association is not completed in the trial time period. In each of the above examples, the association delay statistics may be computed using mean (e.g., integer), percentile, and/or time values based on AP 105 measurements or mobile device 115-b provided reports.

In some cases, a mobile device 115-b may transition from communicating primarily with a first AP 105-c to communicating primarily with a second AP 105-d. For example, the mobile device 115-b may move and determine that the second AP 105-d provides better coverage than the first AP 105-c. Despite making this determination, the mobile device 115-b may have traffic to send or receive while transitioning to the second AP 105-d. The mobile device 115-b may thus request authorization with the second AP 105-d, and then continue communications with the first AP 105-c. For instance, the mobile device 115-b may tune to the first AP 105-c to resume traffic during an estimated delay period, and then it may tune back to the second AP 105-d after the estimated delay period to receive the authorization response transmitted from the second AP 105-d. By continuing communications with the first AP 105-c while waiting for a response from the second AP 105-d, the mobile device 115-b may communicate in a more timely manner and experience less coverage degradation associated with transitioning between APs 105.

In some cases, however, if the mobile device 115-b does not timely tune back to the second AP 105-d to receive the authorization response transmitted from the second AP 105-d, handover delay may be increased or service quality may be degraded. For example, the mobile device 115-b may tune to the second AP 105-d much earlier or later than the authorization response from the second AP 105-d is ready to be received. This may cause the mobile device 115-b to transmit another authorization request, or wait an undesirable amount of time to receive the authorization response from the second AP 105-d. Such added delay may result in the mobile device 115-b communicating with the first AP 105-c longer than preferred, while the first AP 105-c may no longer be capable of providing the desired service quality. In some examples, the first AP 105-c may be an example of a source AP.

To reduce delays or service degradation associated with inter-AP mobility, the second AP 105-d may transmit a delay estimation message 220 to the mobile device 115-b. In some examples, the second AP 105-d may be an example of a target AP. The delay estimation message 220 may include an estimated authorization response delay or information that the mobile device 115-b may use to estimate a delay. The estimated authorization response delay may indicate the amount of time before the mobile device 115-b can expect to receive a message, such as an authorization response. The delay estimation message 220 may be transmitted from the second AP 105-d and received at the mobile device 115-b. Additionally or alternatively, the delay estimation message 220 may be transmitted from the second AP 105-d to the first AP 105-c, and, in turn, transmitted from the first AP 105-c to the mobile device 115-b. The delay estimation message 220 may also be determined by another network component, such as a central node 130, and transmitted directly, or through an AP 105, to the mobile device 115-b.

The mobile device 115-b, such as by using the association coordination component 225, may use the delay estimation message 220 to determine when to tune back to the second AP 105-d. For example, the mobile device 115-b may transmit an authorization request to the second AP 105-d, which may transmit delay estimation message 220 to the mobile device 115-b. The mobile device 115-b may then continue to use the first AP 105-c until a time indicated by the delay estimation message 220 (e.g., expiration of an estimated authorization response delay), after which the association coordination component 225 may cause the mobile device 115-b to tune to the second AP 105-d and receive a response from the second AP 105-d. This may reduce a delay or potential delay and may allow the mobile device 115-b to continue communications while awaiting response from the AP 105-d.

In some cases, the delay estimation message 220 is transmitted from the second AP 105-d if the estimated authorization response delay exceeds a threshold. The threshold may be determined by the delay determination component 210 and may be determined in real-time, signaled, or predefined. The mobile device 115-b may use the association coordination component 225 to transmit the delay estimation message 220 to the first AP 105-c, so the first AP 105-c has knowledge of when the mobile device 115-b will tune to the second AP 105-d. In some cases, the mobile device 115-b (e.g., through the association coordination component 225) may transmit a message, such as a leave notification, to the first AP 105-c at a time based on the delay estimation message 220 (e.g., after expiration of an estimated authorization response delay). The mobile device 115-b (e.g., through the association coordination component 225) may also transmit a message, such as a poll for response, to the second AP 105-d at a time based on the delay estimation message 220 (e.g., after expiration of an estimated authorization response delay). The poll for response may trigger the second AP 105-d to transmit the authorization response to be received by the mobile device 115-b.

In addition to, or instead of, an estimated authentication response delay, the delay estimation message 220 may include estimated response delays for other servers. For example, the delay estimation message 220 may include an estimated internet protocol (IP) address response delay (e.g., for an IP address response in a dynamic host configuration protocol (DHCP) server), an estimated domain name system (DNS) response delay (e.g., for a DNS response in a DNS server), an estimated address resolution protocol (ARP) response delay (e.g., for a ARP response in a gateway server), an estimated association response delay, an estimated authentication authorization and accounting (AAA) extensible authentication protocol (EAP) response delay (e.g., for an authentication server). Indeed, the delay estimation message 220 may include any delay information relevant to the mobile device 115-b. For example, the delay estimation message 220 may incorporate delays between an authentication request and an authentication response, between an association request and an association response, or between an authentication request and an association response. Further, the association coordination component 225 may be used to coordinate mobile device 115 association with an AP 105, coordinate mobile device 115 authorization with an AP 105, or otherwise coordinate communications between a mobile device 115 and an AP 105.

The delay estimation message 220 may be determined, or estimated, by the second AP 105-d (e.g., by the delay determination component 210). The delay determination component 210 may, for instance, estimate an authorization response delay based on a round-trip delay of previous messages exchanged, such as messages exchanged with the mobile device 115-b. Additional ping messages may be used by the delay determination component 210 to estimate the delay estimation message 220 or round-trip delays.

In some cases, mobile device 115-b may be unable to associate with any neighbor AP 105 within range because received signal strength indication (RSSI) and supported MCS for each neighbor AP 105 may be below a threshold. The threshold value may be determined, signaled, predefined, etc. The threshold value may be the same or different, for different APs 105. Communication between the mobile device 115-b and such APs 105 may be sub-optimal, in that it may be a less efficient use of the wireless medium than could be achieved if RSSI or MCS (e.g., access metrics) were above the threshold.

While it may be desirable to limit or avoid such sub-optimal communications, in some cases, wireless communication system 200 may nonetheless support communication links when access metrics fail to meet threshold values. For example, if the mobile device 115-b is unable to receive signaling that satisfies access thresholds from at least one of or a plurality of its neighbor APs 105, the mobile device 115-b may attempt to initiate association with an AP 105 (e.g., AP 105-c) by sending an indicator to the AP 105-c. The indicator may indicate to the AP 105-c that the mobile device's 115-b link quality or maximum MCS is below the requirement of a number of neighbor APs 105. In some cases, the indicator sent from the mobile device 115-b may indicate to the AP 105-c that the mobile device's 115-b link quality or maximum MCS is below a threshold for all neighbor APs 105. The indicator may be sent from the mobile device 115-b to a single AP 105-c or to a number of APs 105. After receiving the indicator from the mobile device 115-b, the AP 105-c may transmit the indicator, or another message including information based on the indicator, to another AP 105-d or another network component. In some cases, the AP 105-c (e.g., AP association coordination component 230) may grant access to the mobile device 115-b based on the indicator.

The mobile device 115-b may send other values in addition to the indicator. For example, the mobile device 115-b may determine and transmit a usage value which may indicate a maximum percentage of air time the mobile device 115-b will use. Additionally or alternatively, the usage value may indicate a maximum percentage of time-frequency resources or a maximum throughput to be used by the mobile device 115-b. The AP 105-c may grant access to the mobile device 115-b based on the indicator and other values transmitted by the mobile device 115-b. For example, the AP 105-c may grant access to the mobile device 115-b if the mobile device has transmitted the indicator and the usage value, and if the usage value is below a usage value threshold. The usage value threshold may be determined, signaled predefined, etc. If the mobile device 115-b transmits the indicator and the usage value, and the usage value is not below the usage value threshold, the AP 105-c may transmit a response declining access to the mobile device 115-b. A suggested usage value may be transmitted from the AP 105-c to the mobile device 115-b, such as if the AP 105-c declines access to the mobile device 115-b. The suggested usage value may be received at the mobile device 115-b and used to determine a new usage value if the mobile device 115-b tries again to access the AP 105-c. The indicator or the usage value may be transmitted from the mobile device 115-b and received at the AP 105-c via a probe, an authorization request, an association request, etc.

The other values which may be transmitted in addition to the indicator may include a traffic type indicator or a network availability indicator. The traffic type indicator may indicate the type of traffic of the mobile device 115-b. For example, the traffic type indicator may indicate whether the mobile device 115-b is with or without traffic (e.g., indicated through a single bit). The traffic type indicator may indicate whether the mobile device 115-b has real-time traffic, non-real-time traffic, or no traffic (e.g., indicated through multiple bits). The AP 105-c may grant access to the mobile device 115-b if the traffic type indicator indicates that the mobile device 115-b has real-time traffic, or if the mobile device 115-b has traffic. The network availability indicator may indicate whether traffic from the mobile device 115-b can continue on an alternate network. For example, an alternate network may include a network other than the network of AP 105-c, such as a cellular network. The AP 105-c may grant access to the mobile device 115-b if the network availability indicator indicates that the traffic of the mobile device 115-b cannot continue on an alternate network.

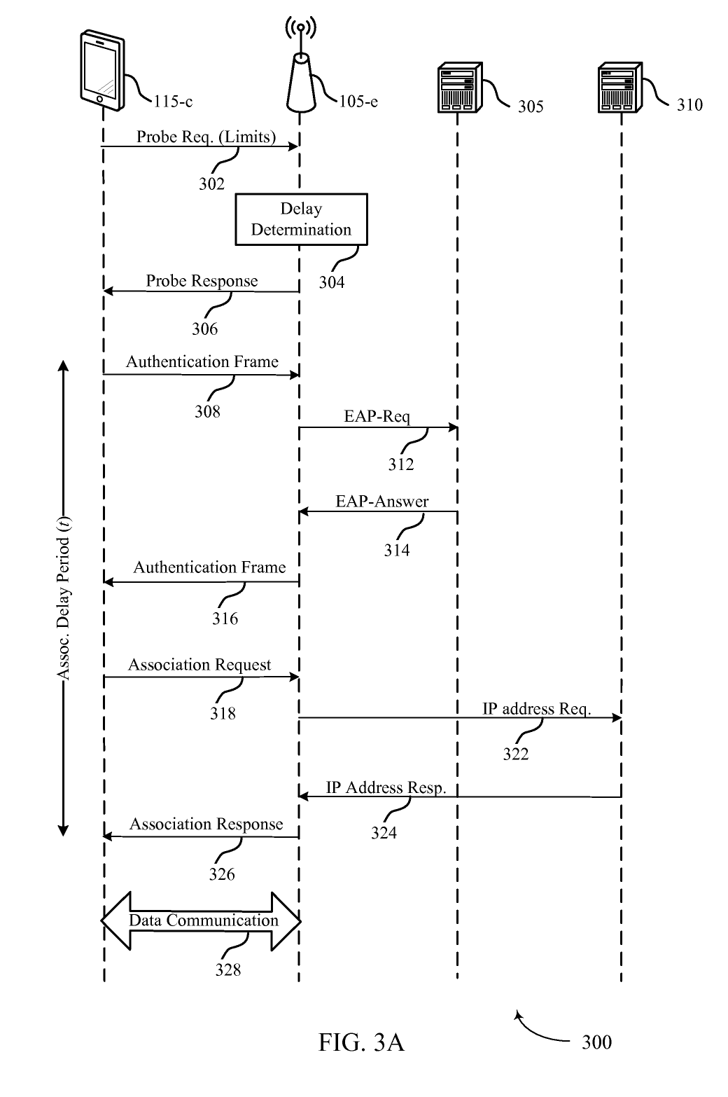

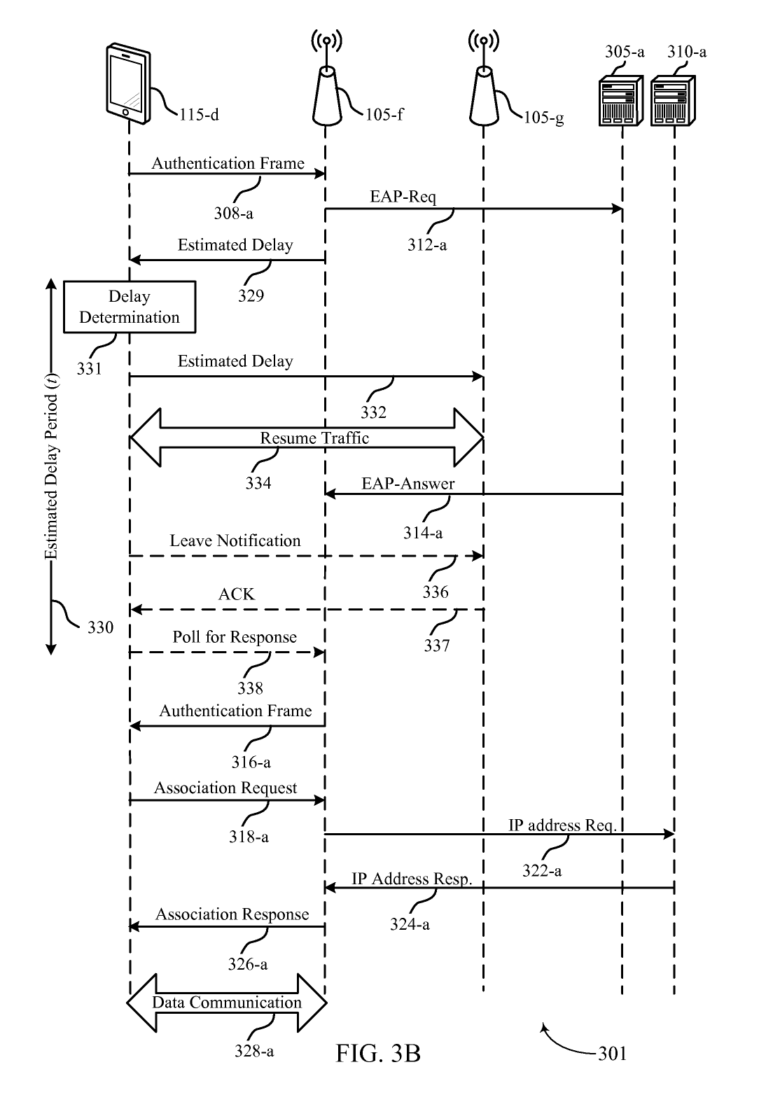

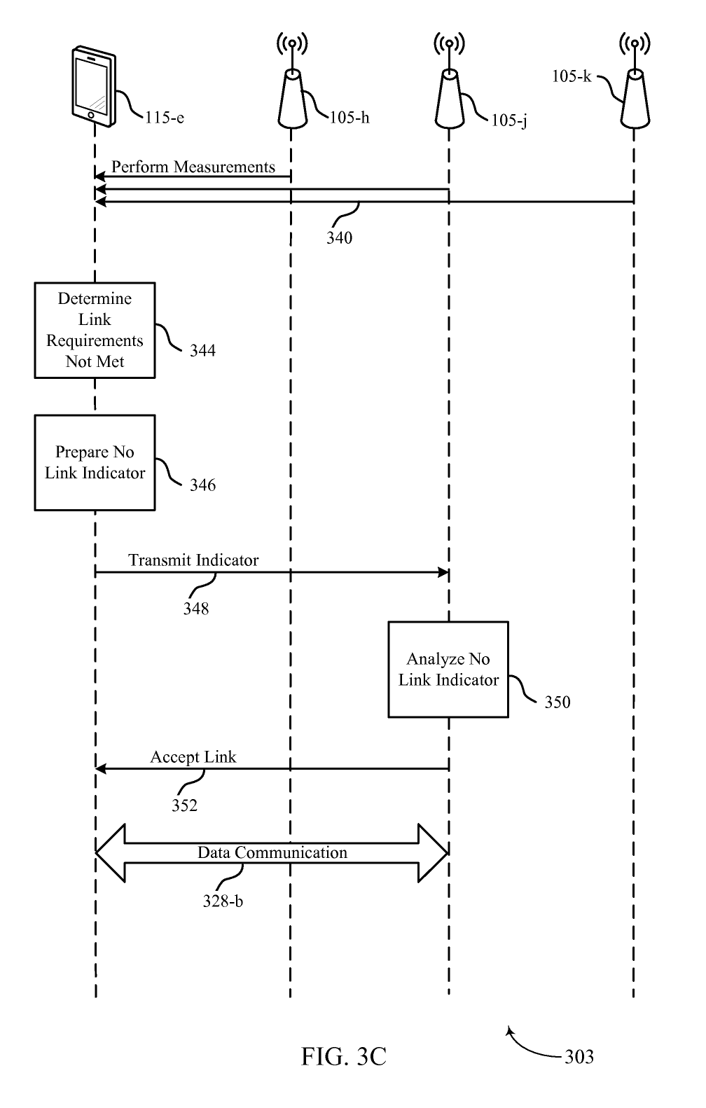

Next, FIG. 3A illustrates an example of a message flow 300 for selecting an access point based on association performance in accordance with various aspects of the present disclosure. The message flow 300 may include mobile device 115-c, which may be an example of a mobile device 115 described above with reference to FIGS. 1 and 2. The message flow 300 may also include AP 105-e, which may be an example of an AP 105 described above with reference to FIGS. 1 and 2. Additionally, the message flow 300 may include one or more servers (e.g., authentication server 305 and DHCP server 310), which may be an example of a server or a central node 130 described above with reference to FIGS. 1 and 2.

The mobile device 115-c may transmit a message 302 (e.g., probe request), which may include one or association delay limits (e.g., thresholds) to AP 105-e. The association delay limits may identify maximum authentication server RTD, maximum overall association delay, and/or maximum association failure rate parameters. In some examples, the limits may be included in a FILS request parameter element. The AP 105-e, upon receiving message 302, may identify and/or extract the limits, calculate association delay metrics, and, at block 304, determine whether the calculated metrics satisfy the limits provided by mobile device 115-c. Based on a determination that AP 105-e satisfies all the limits indicated—e.g., upon determining that AP 105-e may meet thresholds for maximum authentication server RTD, etc.—AP 105-e may transmit a message 306 (e.g., probe response) to the mobile device 115-c. In some examples, the probe response message may include an identifier that may indicate to mobile device 115-c that AP 105-e satisfies all of the limits of mobile device 115-c. Additionally or alternatively, the message 306 may include the calculated association delay metrics for AP 105-e. In some examples, AP 105-e may transmit the association delay metrics using the access network query protocol (ANQP) element carried in beacon and/or probe response message.

The mobile device 115-c, upon receiving message 306, may select AP 105-e for association. For example, mobile device 115-c may transmit an authentication frame 308 to AP 105-e. Then, AP 105-e may transmit an EAP-request message 312 to authentication server 305, which may respond to AP 105-e with an EAP-answer frame 314. In some examples, AP 105-e returns an authentication frame 316 based on receiving an EAP-Answer frame 314 from the authentication server 305.

The mobile device 115-c may then transmit an association request 318 to AP 105-e. The AP 105-e may then request an IP address 322 for the mobile device 115-c from the DHCP server 310, and it may receive an IP address response 324. The AP 105-e may then transmit an association response 326 to the mobile device 115-e to complete the authentication and association procedure. Upon successful completion of the authentication and association procedure, mobile device 115-c may establish data communication 328 with the AP 105-e.

The association delay may include an elapsed time from issuance (e.g., transmission) of the authentication frame 308 to reception of the association response 326. The mobile device 115-c may anticipate the association delay may be consistent with limits specified in the message 302. Or, in some examples, an AP 105 may broadcast association delay metrics without receiving a prior request from a mobile device 115. In some examples the mobile device 115-c may select AP 105-e based on the broadcasted association delay metrics. Additionally or alternatively, the mobile device 115-e may only consider APs 105 whose association delay metrics fall below a threshold limit. In other examples, the mobile device 115-c may select the AP based on the weighted sum of association delay metrics and other metrics provided by the AP. For instance, the mobile device 115-c may jointly consider an association delay metric of the AP 105-e in conjunction with at least one other metric (e.g., channel load and/or received signal strength indication associated with the AP 105-e). But in the absence of specified limits or broadcasted metrics, mobile device 115-e may associate with an AP 105 without prior knowledge or an association delay. Thus, selecting an AP 105-e based, to some extent, on an anticipated association delay may improve efficiency within a system (e.g., wireless communication system 100 of FIG. 1) because a mobile device 115 may avoid APs 105 with higher association delays. In other words, communication delays may be avoided by providing for AP selection based on association performance.

FIG. 3B illustrates an example of a message flow 301 for coordinating with an access point based on association performance in accordance with various aspects of the present disclosure. The message flow 301 may include mobile device 115-d, which may be an example of a mobile device 115 described above with reference to FIGS. 1 and 2. The message flow 301 may also include APs 105-f and 105-g, which may be examples of an AP 105 described above with reference to FIGS. 1 and 2. Additionally, the message flow 301 may include one or more servers (e.g., authentication server 305-a and DHCP server 310-a), which may be an example of a server or a central node 130 described above with reference to FIGS. 1 and 2, or authentication server 305 and DHCP server 310 described above with reference to FIG. 3A.

At 308-a, the mobile device 115-d may transmit an authorization request message to a target AP 105-f The AP 105-f may receive the authorization request and, at 312-a, transmit an extensible authentication protocol (EAP) request to authentication server 305-a.

At 329, the AP 105-f may transmit and the mobile device 115-d may receive a delay estimation message in response to the authorization request message. The delay estimation message may include information indicative of an authentication delay, or a delay associated with communication to another server or network entity, as discussed above. For instance, the delay estimation message may be associated with an authentication server delay, DHCP server 310-a, a domain name system (DNS) server, or a gateway. In some examples the delay estimation message is associated with a delay estimated by the target AP 105-f based on a round-trip time of a previous message exchange.

At 331, the mobile device 115-d may determine an estimated delay period 330 based on information provided by the delay estimation message. Then, at 332, the mobile device 115-d may transmit a delay timing message that includes the estimated delay period to a source AP 105-g. The source AP 105-g may receive the delay timing message, and, at 334, the mobile device 115-d and the source AP 105-g may resume traffic communication during the estimated delay period. In some examples, the mobile device 115-d may determine that the estimated delay period exceeds a delay threshold, and the delay timing message is transmitted and the traffic communication resumed based on the estimated delay period exceeding the delay threshold.

At 314-a, the AP 105-f may receive from the authentication server 305-a an EAP answer message, which may include an authentication response to the mobile devices 115-d authentication request. Because the mobile device estimated the authentication delay period the mobile device 115-d may timely tune to AP 105-f to receive an authentication response. In some examples, the mobile device 115-d may, at 336, transmit, and the source AP 105-g may receive, a notification message after the mobile device 115-d determines that the estimated delay period has expired or exceeds the delay threshold. The notification message may alert the source AP 105-g that the mobile device 115-d will tune away, and the AP 105-g may cease traffic communication with the mobile device 115-d accordingly. The mobile device 115-d may tune to the target AP 105-f after transmitting the notification message or, in some cases, at 337, receipt of an acknowledgment of the notification message by the source AP 105-g.

The mobile device 115-d may tune to the target AP 105-f after the estimated delay period 330. In some examples, at 338, the mobile device 115-d may transmit a polling message to the target AP 105-f and thereafter tune to the target AP 105-f The target AP 105-f may, at 316-a, transmit an authentication response. The authentication response may be transmitted in response to the AP 105-f receiving the EAP answer from the authentication server 305-a, or in response to the polling message, or both. The mobile device 115-d may receive an authentication response message from the target AP 105-f The mobile device 115-d may receive the authentication response message in response to the polling message.

The mobile device 115-d and target AP 105-f may then perform an association procedure. For example, at 318-a, the mobile device 115-d may transmit and the AP 105-f may receive an association request. The AP 105-f may, at 322-a, transmit an IP address request message to DHCP server 310-a; and, at 324-a, AP 105-f may receive an IP address response message. Then, at 326-a, AP 105-f may transmit, and mobile device 115-d may receive an associate response. The mobile device 115-d and AP 105-f may initiate traffic communication at 328-a.

FIG. 3C illustrates an example of a message flow 303 for coordinating with an access point based on association performance in accordance with various aspects of the present disclosure. The message flow 303 may include mobile device 115-e, which may be an example of a mobile device 115 described above with reference to FIGS. 1 and 2. The message flow 303 may also include APs 105-h, 105-j, and 105-k, which may be examples of an AP 105 described above with reference to FIGS. 1 and 2. Additionally, the message flow 303 may include one or more servers (e.g., authentication server 305-a and DHCP server 310-a), which may be an example of a server or a central node 130 described above with reference to FIGS. 1 and 2.

At 340, APs 105-h, 105-j, and 105-k (which, in some examples, may be examples of a plurality of neighbor APs) may each transmit a signal that includes or is indicative of access metrics to mobile device 115-e. The signals may be broadcast or may be transmitted in response to a request from mobile device 115-e. The mobile device 115-e may receive a signal from each of APs 105-h, 105-j, and 105-k, which may be referred to as neighbor APs; and the signals may each include or be indicative of an access metric. In some examples, the access metric includes an RSSI or a supported MCS, or both.

At 344, mobile device 115-e may determine that at least one of the received access metrics, or received signals, fails to meet an access threshold for at least one of the APs 105-h, 105-j, or 105-k, which in some examples may be examples of neighbor APs 105. The access threshold may be an RSSI threshold or a maximum supported MCS threshold, or both. At 346, mobile device 115-e may thus prepare or generate a message indicating that it cannot establish a communication link because a neighbor AP 105 (or a plurality of or all neighbor APs 105) has insufficient access metrics.

At 348, mobile device 115-e may transmit an indication message to a neighbor AP 105 (e.g., AP 105-j) that at least one of the access metrics fails to meet the access threshold for one of the APs 105-h, 105-j, or 105-k. In some cases, mobile device 115-e may transmit the indication to all APs 105; and in some cases, the message may indicate that none of the APs 105 has sufficient access metrics. The mobile device 115-e may transmit the indication to a single AP 105-j, where the AP 105-j may have preferable access metrics compared to other neighbor APs 105. The indication message may be transmitted in, for example, a probe, an authentication request, an association request, or the like. In some cases, the indication message includes a required resource use value, which may include a required air time usage parameter, a required time-frequency resource usage parameter, a required throughput parameter, or the like. Additionally or alternatively, the indication message may include a traffic type value indicative of a least one of a no traffic type, a with-traffic type, a real-time traffic type, or a non-real-time traffic type, or the like. In some cases, the indication message includes a network availability value indicative of whether a device is able to fall back to a network exclusive the neighbor APs' 105 network (e.g., a cellular network).

One or several APs 105 may receive the indicator. At 350, an AP 105 that has received the indicator (e.g., AP 105-j) may analyze the message. The AP 105 may determine that, based on the indicator, whether it can support communication with mobile device 115-e, even if at a reduced or sub-optimal level.

At 352, the AP 105 may thus transmit, and mobile device 115-e may receive a message in response to the indication message. In some examples, the responsive message received from the AP or APs 105 is responsive to the required resource use value in the indicator, and the responsive message may include an access denial or a suggested resource use, or both. Or, the responsive message may be received from the AP or APs 105 in response to the traffic type value of the indicator. Or, in some examples, the responsive message may be received from the AP or APs is responsive to the network availability value—e.g., based on whether mobile device 115-e can avail itself of a connect to another network, such as a cellular network, in the absence of establishing a link with one of the APs 105. In any event, an AP 105 that analyzes the indicator and generates a response, may generate and send a responsive message based on a capability, needs, classification, type, or other characteristic of mobile device 115-e, and based on an the AP's 105 ability to satisfy or communicate according to such characteristics. At 328-b, mobile device 115-e may associate with an AP 105 based on receiving the responsive message.

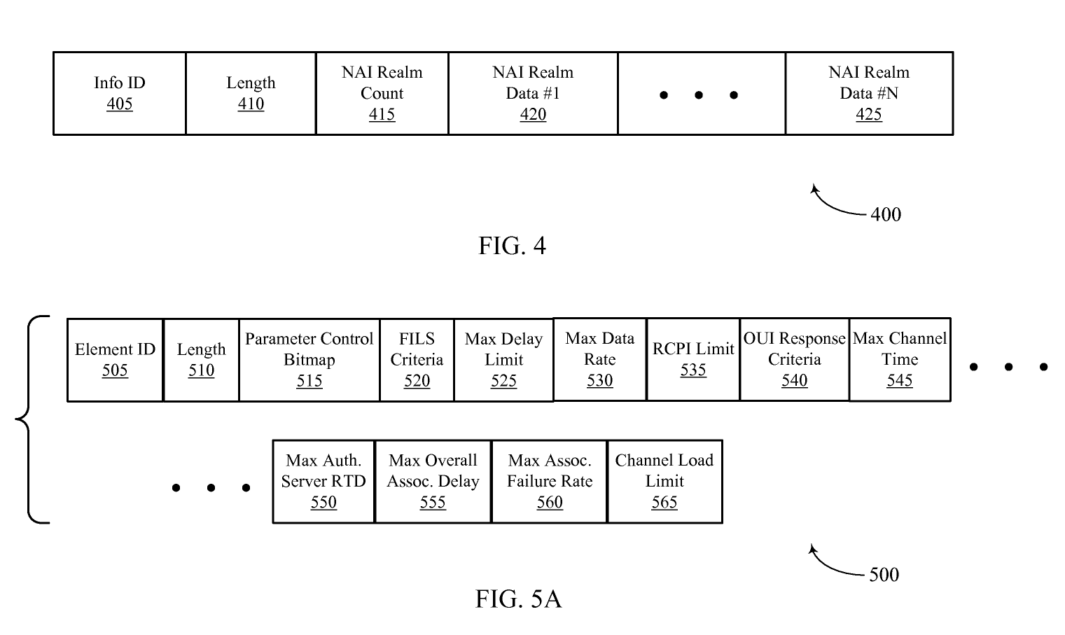

FIG. 4 illustrates an example of a probe response message 400 for selecting an access point based on association performance in accordance with various aspects of the present disclosure. In some examples, an AP 105 (FIGS. 1-3C) may transmit association delay metrics for multiple service provider networks to mobile devices 115 (FIGS. 1-3C) using an ANQP-element carried in beacon and probe response message. In some examples, an AP 105 may broadcast a probe response message 400.

The probe response message 400 may include information identification (ID) 405, frame length 410, network access identifier (NAI) realm count 415, and one or more optional NAI realm data elements 420 and 425. Metrics for each service provider network may be added to NAI realm data elements 420 and 425. In some examples, a mobile device 115 may receive the probe response message 400 and determine the association delay metrics associated with an AP 105. Based on the reception of the probe response message 400, a mobile device 115 may select an AP 105 for association.

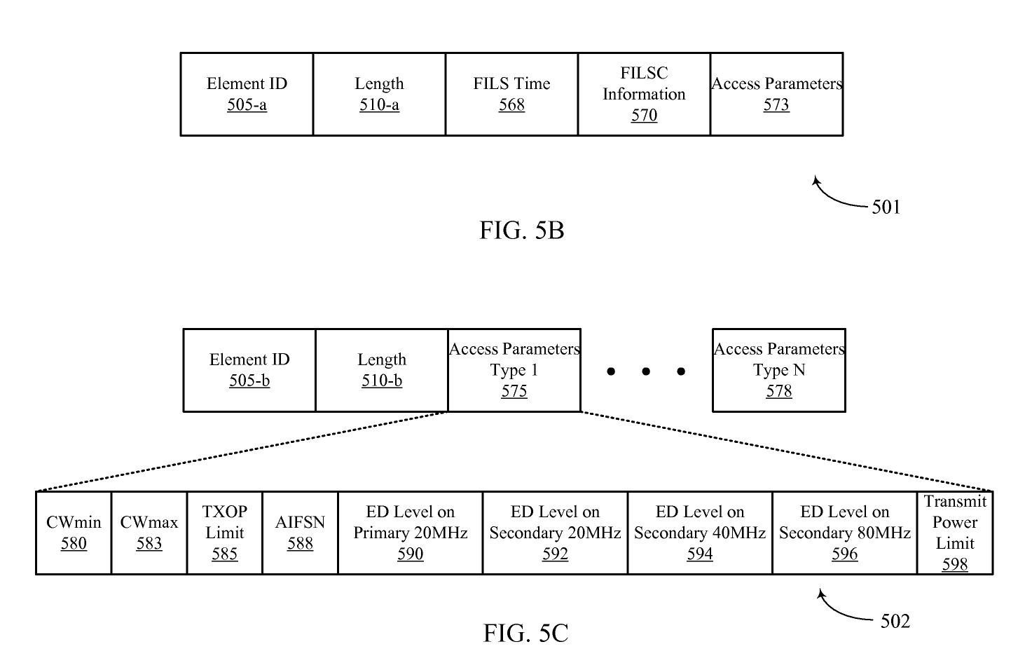

FIG. 5A illustrates an example of a fast initial link setup (FILS) request message 500 for selecting an access point based on association performance in accordance with various aspects of the present disclosure. In some examples, a mobile device 115 (FIGS. 1-3C) may transmit a request message 500 to identify association performance limits, including association delay and/or channel load, for an AP 105 (FIGS. 1-3C). It should be understood by those in the art that although, in some examples, one or more association performance parameters are identified as maximum performance limits, each of the parameters may be threshold limits. Maximum values are not intended to apply absolute values.

The request message 500 may include element identification (ID) 505, frame length 510, parameter control bitmap 515, FILS criteria 520, maximum delay limit 525, maximum data rate 530, received channel power indicator (RCPI) limit 535, organizationally unique identifier (OUI) response criteria 540, and/or maximum channel time 545. In some examples, the request message 500 may also include maximum authentication server RTD limit 550, maximum overall association delay limit 555, maximum association failure rate limit 560, and/or channel load limit 565. The limits may be examples of the limits described above. In some examples, an AP 105, upon receiving the request message 500 may calculate its respective association performance metrics and determine whether the calculated metrics satisfy the requirements identified in request message 500. As discussed above, an AP 105 may respond to a mobile device 115 if its metrics satisfy indicated limits; and the AP 105 may refrain from responding if its metrics do not satisfy indicated limits. In addition, the request message 500 could be carried in a probe request, while the response from AP 105 could be carried in a probe response.

FIG. 5B illustrates example of a differentiated initial link setup (DILS) element 501 that supports selecting and coordinating with an access point in accordance with various aspects of the present disclosure. In some examples, an AP 105 (FIGS. 1-3C) may be configured to communicate with several mobile devices 115 (FIGS. 1-3C). Association of the mobile devices 115 with the AP 105 may be more efficient than is otherwise achievable if the AP 105 partitions the mobile devices 115 into or recognizes the mobile devices 115 as mobile device groups. Each group of mobile devices 115 may perform an association with the AP 105. In some cases, a FILS procedure may be used to associate a mobile device 115 with an AP 105. A FILS procedure may include a DILS element 501. The DILS element 501 may be beneficial to the AP 105 when associating with multiple mobile device groups. For example, the DILS element 501 may specify individual time slots for different mobile device groups to perform association. As such, contention among a large number of mobile devices 115 may be reduced through time division multiplexing (TDM) the association of different groups of mobile devices 115. However, a time slot for a mobile device group may be too long, and create inefficiencies, if the mobile device group has light association traffic, or not many mobile devices 115 as a part of the group.

To address inefficiencies associated with light association traffic from a first group of mobile devices 115, a second group of mobile devices 115 may be configured to associate using the association time frame of the first group of mobile devices 115. The second group of mobile devices 115 may be able to use the association time frame of the first group of mobile devices 115, though the second group of mobile devices 115 may have a lower priority to do so. As such, the AP 105 may attempt to associate with the first group of mobile devices 115 during the association time frame of the first group of mobile devices 115, and may further attempt to associate with at least some of the second group of mobile devices 115 during the same time frame if there is enough time to do so. In some examples, the second group of mobile devices 115 includes devices that would otherwise (e.g., under another association regime) not be allowed to contend for access to the AP 105.

The DILS element 501 may include element identification 505-a, frame length 510-a, FILS time 568, FILS category (FILSC) information 570, and access parameters 573. The FILS time 568 may indicate a time for a mobile device 115, or a mobile device group, to attempt association. Different groups of mobile devices 115 may be assigned different times to associate with an AP 105. The FILS time 568 may indicate a different association time for each mobile device 115 or for each mobile device group. In some cases, different mobile devices 115, or different mobile device groups, may share an association time.

The FILSC information 570 may be used to determine a priority level, such as for association. Priority level may be compared between mobile devices 115, or mobile device groups, to determine which mobile devices 115 have priority to attempt association. The higher priority mobile devices 115 may attempt association before lower priority mobile devices 115, if the higher and lower priority mobile devices 115 are scheduled to attempt association during the same time frame.

The DILS element 501 may be transmitted to an AP 105 or may be transmitted to a mobile device 115. Similarly, the DILS element 501 may be received at an AP 105 or may be received at a mobile device 115. The DILS element 501 may further include access parameters 573, which may be referred to as access priority parameters. The access parameters 573 may signal priority or threshold values to mobile devices 115 or groups of mobile devices 115. Specifically, the access parameters 573, or DILS element 501, may include enhanced distributed channel access (EDCA) parameters or energy detection (ED) threshold values. The EDCA parameters may be signaled with exact values or an index of a corresponding access category (e.g., background (AC_BK), best effort (AC_BE), video (AC_VI), voice (AC_VO), etc.). The ED threshold may be signaled across multiple sub-channels, or for each sub-channel (e.g., primary, secondary, 20 MHz, 40 MHz, 80 MHz, etc.). Different access parameters 573 may be specified for different types of mobile devices 115, or mobile device groups. For example, access parameters 573 within mobile device groups may be specific to mobile devices 115 which have traffic or do not have traffic. Similarly, access parameters 573 within mobile device groups may be specific to mobile devices 115 which have real-time traffic, non-real-time traffic, or no traffic. Access parameters 573 may give higher priority to mobile devices 115 which have traffic, or real-time traffic, compared to those which have no traffic, or non-real-time traffic.

In some examples, AP 105 may transmit the DILS element 501 to several mobile device groups, which may include a first group of mobile devices 115, a second group of mobile devices 115, and a third group of mobile devices 115. The first mobile device group may be scheduled to attempt association with the AP 105 during a first association time frame, while the second and third mobile device groups may be scheduled to attempt association with the AP 105 during a second association time frame, which may be after the first association time frame. The third mobile device group may have lower priority, which may be signaled by the FILSC information 570 or access parameters 573, than the second mobile device group.

During the first association time frame, the AP 105 may attempt to associate with the first group of mobile devices. The energy of the channel may fall below the ED threshold (e.g., as signaled using the access parameters 573) during the first association time frame because there are no, or few, mobile devices 115 in the first mobile device group which still need to associate with the AP 105. If the energy of the channel falls below the ED threshold during the first association time frame, then the mobile device groups scheduled for the second association time frame may attempt to associate with the AP during the time remaining in the first association time frame. The second mobile device group may attempt to associate with the AP 105 during the first association time frame before the third mobile device group since the second mobile device group has a higher priority than the third mobile device group. In some cases, the third mobile device group may not attempt to associate with the AP 105 during the first association time frame and may wait until the second association time frame, since the third mobile device group has a lower priority. During the second association time frame, the mobile devices 115 from the second mobile device group which have not yet attempted to associate with the AP 105 may attempt to associate with the AP 105 before the third mobile device group attempts to associate with the AP 105.

The AP 105 may thus identify a time duration for contention-based access, and it may transmit a link setup message that include one or several access priority parameters to manage access by a first set (or group) of mobile devices 115 to the AP 105 during the identified time duration. In some examples, the mobile devices 115 of the first set are pre-association devices of the AP 105. The AP 105 may select values for the access priority parameters based on an association priority from a second set (or group) of pre-association devices of the AP 105 during the identified time duration, and the second set of pre-association devices may have a higher association priority than the first set of pre-association devices.

In some examples, the access priority parameters include an EDCA parameter, an ED threshold parameter, PD threshold parameter, a transmit power lower or upper limit parameter, or the like. The EDCA parameter may include an exact value or an index corresponding to an access category of a pre-association device, or both. In some cases, the access priority parameters include a number of ED threshold parameters, and each ED threshold parameter may correspond to a different sub-channel (e.g., primary, secondary, 20 MHz, 40 MHz, 80 MHz, etc.). The access priority parameters may include subsets of access priority parameters, such that each subset may correspond to a classification for each pre-association device of the first set of wireless devices. The classification may be, for instance a pre-association device with traffic or a pre-association device without traffic. Or, the classification may be a pre-association device with real-time traffic, a pre-association device with non-real-time traffic, a pre-association device with no traffic, or the like.

In other examples, a DILS element, such as DILS element 501, may be used to control mobile devices 115 that are already associated with an AP 105. By controlling (e.g., modifying or adjusting) these post-association mobile devices 115, it may allow an AP 105 to coordinate association with new (e.g., pre-association) mobile devices 115. In some cases, pre-association mobile devices 115 may be significantly delayed due to contention with post-association mobile devices 115, which may have traffic with AP 105. Often, pre-association mobile devices 115 may use a default access class (e.g., AC_VO) for association with the AP 105. If the AP 105 is already communicating with a number of post-association mobile devices 115 that have a relatively high access class (e.g., AC_VI or AC_VO), the pre-association mobile devices 115 may get little air time, which may be impede or prohibit association.

The AP 105 may signal, e.g., with DILS element 501, post-association (e.g., associated or already-associated) mobile devices 115 to control the wireless medium. For example, the AP 105 may specify EDCA parameters and an ED threshold for these post-association mobile devices 115. The access parameters 573 for post-association mobile devices 115 may be used during the time indicated through the DILS element 501. The access parameters 573 sent to post-association mobile devices 115 may include less aggressive parameters than the associated mobile devices 115 were previously using if the existing traffic is heavy, which may help reduce traffic. In some cases, the AP 105 may signal a no access indicator as a part of the access parameters 573. The no access indicator may prohibit post-association mobile devices 115 from communicating with the AP 105 during the indicated time frame (e.g., time period or duration). The no access indicator may be set if the load of existing traffic exceeds a traffic threshold or if a high association load is detected. The access parameters 573 may include carrier sense multiple access (CSMA) access parameters. In some cases, different access parameters 573 may be signaled to different groups of associated mobile devices 115 (e.g., mobile devices 115 with different access categories, mobile devices 115 with different traffic loads, etc.).

An AP 105 may thus identify a time duration for contention-based access, and it may transmit a link setup message that includes one or several access priority parameters to manage access by a first set (or group) of mobile devices 115 to the AP 105 during the identified time duration. In some examples, the mobile devices 115 of the first set may include post-association devices of the AP 105. The AP 105 may select values for the access priority parameters based on a medium usage by the post-association mobile devices 115, a medium usage by a set of pre-association mobile devices 115, an access category of a post-association device, or the like. In some examples the access priority parameters comprise a no access indicator.

FIG. 5C illustrates example of an access parameter set information element (IE) 502 that supports selecting and coordinating with an access point in accordance with various aspects of the present disclosure. In some examples, an AP 105 (FIGS. 1-3C) may transmit access parameters in the IE 502 to be received at mobile devices 115 (FIGS. 1-3C). The IE 502 may be included in a beacon, or may be a response, such as a response to a probe or association request.

In some examples, the same CSMA access parameters are used by all mobile devices 115 with all pre-association (e.g., new) mobile devices 115. For instance, the pre-association mobile devices may use EDCA parameters in AC_VO. As such, association priority may not be differentiated among different types of new mobile devices 115. Differentiation may be achieved through DILS (e.g., as described with respect to FIG. 5B), though DILS may only be activated after a high association load is detected. It may be beneficial to differentiate association priority even in the absence of DILS. The IE 502 may be used to differentiate new mobile devices 115, even without DILS.

The IE 502 may include an element identification 505-b, a frame length 510-b, and access parameters for a number of mobile device 115 types, such as access parameters type 1 575 and access parameters type N 578. Access parameters 575 through 578 may include CSMA access parameters for different types of new mobile devices 115. Some of, or each of, the access parameters 575 through 578 may include a minimum contention window (CWmin) 580, a maximum contention window (CWmax) 583, a transmit opportunity (TXOP) limit 585, an arbitration inter-frame space (AIFS) number 588, an ED level on the primary 20 MHz carrier 590, an ED level on the secondary 20 MHz carrier 592, an ED level on the secondary 40 MHz carrier 594, an ED level on the secondary 80 MHz carrier 596, or a transmit power limit 598. Access parameters 575 through 578 may be associated with new mobile devices 115 of different types, such as real-time traffic, non-real-time traffic, or no traffic. In some cases, access parameters 575 through 578 may be associated with new mobile devices 115 which have traffic, or have no traffic. Accordingly, priority of association with the AP 105 may be differentiated between new mobile devices 115 of different types. The access parameters 575 through 578 may include EDCA parameters and an ED threshold for different types of new mobile devices 115. In some cases, the access parameters 575 through 578 may include features of the access parameters 573 of FIG. 5B.

An AP 105 may thus identify a set of pre-association devices contending for access, and it may transmit a link setup message that includes access priority parameters to manage access by the set of pre-association devices. The access priority parameters may be based on a classification for each pre-association device; the classification may include a wireless device with traffic or a wireless device without traffic, for instance. Or, in some examples, the classification may be a wireless device with real-time traffic, or a wireless device with non-real-time traffic, or a wireless device with no traffic, or the like. In some examples, the link setup message comprises an IE with access priority parameters associated with a several classifications.

FIG. 6A shows a block diagram 600 of a mobile device 115-f-1 configured for selecting an access point based on association performance in accordance with various aspects of the present disclosure. The mobile device 115-f-1 may illustrate aspects of mobile devices 115 described with reference to FIGS. 1-5C. The mobile device 115-f-1 may include a receiver 605, an access point selection component 610, and/or a transmitter 615. The mobile device 115-f-1 may also include a processor. Each of these components may be in communication with one another.

The components of mobile device 115-f-1 may, individually or collectively, be implemented with at least one application specific integrated circuit (ASIC) adapted to perform some or all of the applicable functions in hardware. Alternatively, the functions may be performed by one or more other processing units (or cores), on at least one IC. In other embodiments, other types of integrated circuits may be used (e.g., Structured/Platform ASICs, a field programmable gate array (FPGA), or another semi-custom IC), which may be programmed in any manner known in the art. The functions of each unit may also be implemented, in whole or in part, with instructions embodied in a memory, formatted to be executed by one or more general or application-specific processors.

The receiver 605 may receive information such as packets, user data, and/or control information associated with various information channels 602 (e.g., control channels, data channels, and information related to selecting an access point based on association performance, etc.). Information may be passed on to the access point selection component 610 via communication link 604, and to other components of mobile device 115-f-1.

The access point selection component 610 may receive an association delay metric from one AP of a plurality of APs, and select an AP of the plurality of APs for association based on the received association delay metric. The access point selection component 610 may transmit the selection 606 to the transmitter 615 for establishing communication with the selected AP.

The transmitter 615 may transmit signals 608 received from other components of mobile device 115-f-1. In some embodiments, the transmitter 615 may be collocated with the receiver 605 in a transceiver component. The transmitter 615 may include a single antenna, or it may include a plurality of antennas.

FIG. 6B shows a block diagram 601 of a mobile device 115-f-2 configured for selecting an access point based on association performance in accordance with various aspects of the present disclosure. The mobile device 115-f-2 may illustrate aspects of mobile devices 115 described with reference to FIGS. 1-6A. The mobile device 115-f-2 may include a receiver 620, an association coordination component 625, and/or a transmitter 630. The mobile device 115-f-2 may also include a processor. Each of these components may be in communication with one another.

The components of mobile device 115-f-2 may, individually or collectively, be implemented with at least one application specific integrated circuit (ASIC) adapted to perform some or all of the applicable functions in hardware. Alternatively, the functions may be performed by one or more other processing units (or cores), on at least one IC. In other embodiments, other types of integrated circuits may be used (e.g., Structured/Platform ASICs, a field programmable gate array (FPGA), or another semi-custom IC), which may be programmed in any manner known in the art. The functions of each unit may also be implemented, in whole or in part, with instructions embodied in a memory, formatted to be executed by one or more general or application-specific processors.

The receiver 620 may receive information such as packets, user data, or control information associated with various information channels 617 (e.g., control channels, data channels, and information related to association performance based AP selection, etc.). Information may be passed on to the association coordination component 625 via communication link 619, and to other components of mobile device 115-f-2.

The association coordination component 625 may, in combination with other components, transmit an authorization request message to a target AP, receive a delay estimation message from the target AP in response to the authorization request message, and determine an estimated delay period based at least in part on information provided by the delay estimation message. The association coordination component 625 may transmit information 621 to the transmitter 630 for coordinating with an AP.

The transmitter 630 may transmit signals 623 received from other components of mobile device 115-f-2. In some examples, the transmitter 630 may be collocated with the receiver 620 in a transceiver component. The transmitter 630 may include a single antenna, or it may include a plurality of antennas.

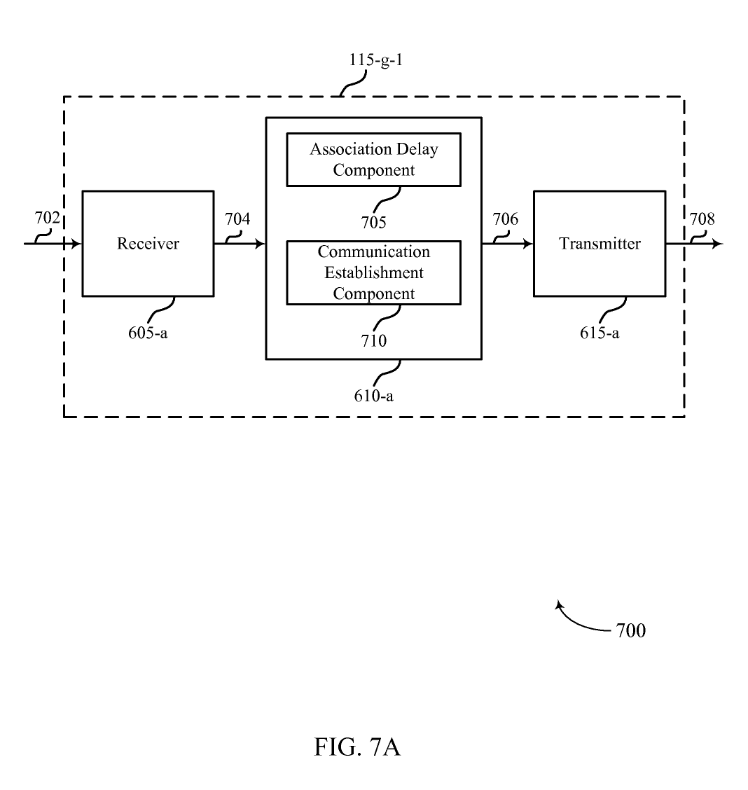

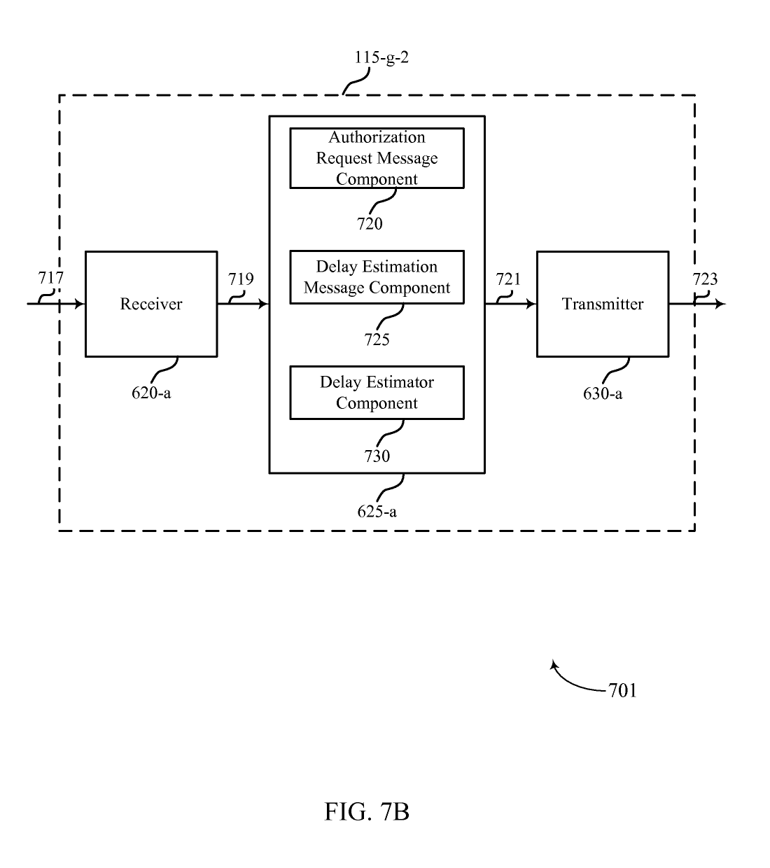

FIG. 7A shows a block diagram 700 of a mobile device 115-g-1 configured for selecting an access point based on association performance in accordance with various aspects of the present disclosure. The mobile device 115-g-1 may illustrate aspects of a mobile device 115 described with reference to FIGS. 1-6B. The mobile device 115-g-1 may include a receiver 605-a, an access point selection component 610-a, and/or a transmitter 615-a. The mobile device 115-g-1 may also include a processor. Each of these components may be in communication with one another. The access point selection component 610-a may also include an association delay component 705, and a communication establishment component 710.

The components of mobile device 115-g-1 may, individually or collectively, be implemented with at least one ASIC adapted to perform some or all of the applicable functions in hardware. Alternatively, the functions may be performed by one or more other processing units (or cores), on at least one IC. In other embodiments, other types of integrated circuits may be used (e.g., Structured/Platform ASICs, an FPGA, or another semi-custom IC), which may be programmed in any manner known in the art. The functions of each unit may also be implemented, in whole or in part, with instructions embodied in a memory, formatted to be executed by one or more general or application-specific processors.

The receiver 605-a may receive information via one or more channels 702 which may be passed on to the access point selection component 610-a via communication link 704, and to other components of mobile device 115-g-1. The transmitter 615-a may receive messages from the access point selection component 610-a via communication link 706 and may transmit signals 708 received from other components of mobile device 115-g-1.

In some examples, the association delay component 705 of the access point selection component 610-a may receive an association delay metric from at least one AP of a plurality of APs, as described above with reference to FIGS. 1-5C. The association delay component 705 may also receive, from the AP, an association delay metric for at least one neighbor AP of the plurality of APs, as described above with reference to FIGS. 1-5C. In some examples, the association delay metric corresponds with a plurality of service provider networks. The association delay metric may include at least one of a RTD statistic between the AP and a network server or a RTD statistic between a station and a network server, or association failure rate, or combination thereof. In some examples, the association delay metric may be based on a response time for a measurement message between a mobile device 115-g-1 and a network server. The association delay metric may, for example, be based on a response time for a measurement message between the AP and a network server.

The communication establishment component 710 may select one AP of the plurality of APs for association based at least in part on the received association delay metric, as described above with reference to FIGS. 1-5C.

FIG. 7B shows a block diagram 701 of a mobile device 115-g-2 configured for selecting an access point based on association performance in accordance with various aspects of the present disclosure. The mobile device 115-g-2 may illustrate of aspects of a mobile device 115 described with reference to FIGS. 1-7A. The mobile device 115-g-2 may include a receiver 620-a, an association coordination component 625-a, and/or a transmitter 630-a. The mobile device 115-g-2 may also include a processor. Each of these components may be in communication with one another. The association coordination component 625-a may also include an authorization request message component 720, a delay estimation message component 725, and a delay estimator component 730.

The components of mobile device 115-g-2 may, individually or collectively, be implemented with at least one ASIC adapted to perform some or all of the applicable functions in hardware. Alternatively, the functions may be performed by one or more other processing units (or cores), on at least one IC. In other examples, other types of integrated circuits may be used (e.g., Structured/Platform ASICs, an FPGA, or another semi-custom IC), which may be programmed in any manner known in the art. The functions of each unit may also be implemented, in whole or in part, with instructions embodied in a memory, formatted to be executed by one or more general or application-specific processors.

The receiver 620-a may receive information 717 which may be passed on to association coordination component 625-a via communication link 719, and to other components of mobile device 115-g-2. The association coordination component 625-a may perform the operations described herein with reference to FIGS. 1-7A. The transmitter 630-a may receive messages from the association coordination component 625-a via communication link 721 may transmit signals 723 received from other components of a wireless device.

The authorization request message component 720 may transmit an authorization request message to a target AP as described herein with reference to FIGS. 1-7A.

The delay estimation message component 725 may receive a delay estimation message from the target AP in response to the authorization request message as described herein with reference to FIGS. 1-7A. In some examples, the delay estimation message may be associated with at least one of an authentication server delay, a dynamic host configuration protocol (DHCP) server, a domain name system (DNS) server, or a gateway, or any combination thereof. In some examples, the delay estimation message may be associated with a delay estimated by the target AP based at least in part on a round-trip time of a previous message exchange.

The delay estimator component 730 may determine an estimated delay period based at least in part on information provided by the delay estimation message as described herein with reference to FIGS. 1-7A. The delay estimator component 730 may also determine that the estimated delay period exceeds a delay threshold, and the delay timing message may be transmitted, and the traffic communication resumed, based on the estimated delay period exceeding the delay threshold.

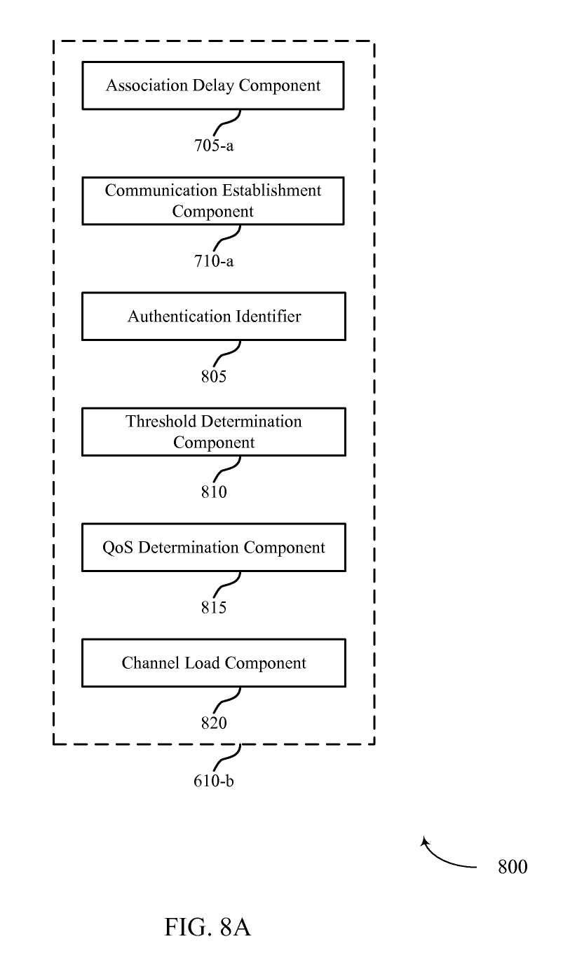

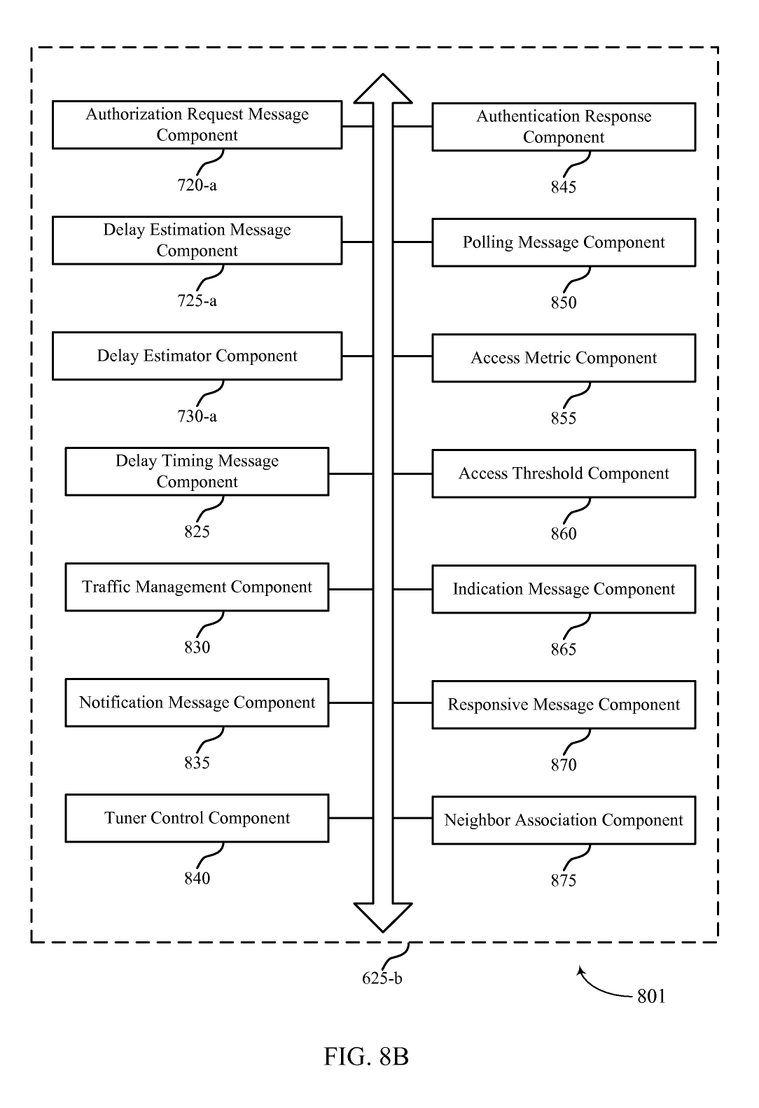

FIG. 8A shows a block diagram 800 of an access point selection component 610-b configured for selecting an access point based on association performance in accordance with various aspects of the present disclosure. The access point selection component 610-b may illustrate aspects of an access point selection component 610 described with reference to FIGS. 6A-7B. The access point selection component 610-b may include an association delay component 705-a and/or a communication establishment component 710-a. Each of these components may perform the functions described above with reference to FIG. 7A. The access point selection component 610-b may also include an authentication identifier 805, a threshold determination component 810, a QoS determination component 815, and a channel load component 820.

The components of the access point selection component 610-b may, individually or collectively, be implemented with at least one ASIC adapted to perform some or all of the applicable functions in hardware. Alternatively, the functions may be performed by one or more other processing units (or cores), on at least one IC. In other examples, other types of integrated circuits may be used (e.g., Structured/Platform ASICs, an FPGA, or another semi-custom IC), which may be programmed in any manner known in the art. The functions of each unit may also be implemented, in whole or in part, with instructions embodied in a memory, formatted to be executed by one or more general or application-specific processors.

The authentication identifier 805 may identify the association delay metric based on an authentication type, as described above with reference to FIGS. 1-7B. In some examples, the association delay metric corresponds with a plurality of authentication types, the authentication types comprising at least one of Extensible Authentication Protocol (EAP) or EAP Re-authentication Protocol (EAP-RP).

The threshold determination component 810 may transmit a threshold limit for at least one association delay metric to the AP. The threshold determination component 810 may limit the number of APs that may respond to the mobile device to only those APs for whom the association delay metric is less than the threshold, as described above with reference to FIGS. 1-7B.

The QoS determination component 815 may be configured such that selecting the AP of the plurality of APs may include determining that the association delay metric of at least one AP satisfies the QoS requirement of a mobile device, as described above with reference to FIGS. 1-7B. In some examples, selecting the one AP of the plurality of APs involves determining that the received association delay metric satisfies a predetermined delay threshold of a mobile device 115 (e.g., mobile device 115-g-1). In some examples, selecting the one AP of the plurality of APs involves determining that the received association delay metric satisfies a predetermined metric threshold of a mobile device 115 (e.g., mobile device 115-g-1).

The channel load component 820 may determine a threshold for at least one channel load metric, as described above with reference to FIGS. 1-7B. The channel load component 820 may transmit a first message that includes the threshold to an AP, as described above with reference to FIGS. 1-7B. The channel load component 820 may also receive a second message from the AP when the channel load metric of the AP satisfies the threshold, as described above with reference to FIGS. 1-7B. In some examples, the threshold limit identifies a maximum number of mobile devices permitted on a primary channel. In some examples, the first message may be a probe request and the second message is a probe response. The first message may be a probe request message and the second message may be a probe response message.

FIG. 8B shows a block diagram 801 of an association coordination component 625-b which may be a component of a mobile device 115 for association performance based AP selection in accordance with various aspects of the present disclosure. The association coordination component 625-b may be an example of aspects of an association coordination component 625 described with reference to FIGS. 6B and 7B. The association coordination component 625-b may include an authorization request message component 720-a, a delay estimation message component 725-a, and a delay estimator component 730-a. Each of these components may perform the functions described herein with reference to FIG. 7B. The association coordination component 625-b may also include a delay timing message component 825, a traffic management component 830, a notification message component 835, a tuner control component 840, an authentication response component 845, a polling message component 850, an access metric component 855, an access threshold component 860, an indication message component 865, a responsive message component 870, and a neighbor association component 875.

The components of the association coordination component 625-b may, individually or collectively, be implemented with at least one ASIC adapted to perform some or all of the applicable functions in hardware. Alternatively, the functions may be performed by one or more other processing units (or cores), on at least one IC. In other examples, other types of integrated circuits may be used (e.g., Structured/Platform ASICs, an FPGA, or another semi-custom IC), which may be programmed in any manner known in the art. The functions of each unit may also be implemented, in whole or in part, with instructions embodied in a memory, formatted to be executed by one or more general or application-specific processors.

The delay timing message component 825 may transmit a delay timing message, which may include the estimated delay period to a source AP as described herein with reference to FIGS. 1-8A. The traffic management component 830 may resume traffic communication with the source AP during the estimated delay period as described herein with reference to FIGS. 1-8A. The notification message component 835 may transmit a notification message to the source AP after determining that the estimated delay period exceeds the delay threshold as described herein with reference to FIGS. 1-8A.

The tuner control component 840 may tune to the target AP after the notification message transmission or receipt of an acknowledgment of the notification message by the source AP as described herein with reference to FIGS. 1-8A. The tuner control component 840 may also tune to the target AP after the estimated delay period.

The authentication response component 845 may receive an authentication response message from the target AP as described herein with reference to FIGS. 1-8A. In some cases, the authentication response component 845 may also receive the authentication response message in response to the polling message. The polling message component 850 may transmit a polling message to the target AP after tuning to the target AP as described herein with reference to FIGS. 1-8A.

The access metric component 855 may receive a signal comprising an access metric from each of a plurality of neighbor APs as described herein with reference to FIGS. 1-8A. In some examples, the access metric includes an RSSI or a supported MCS, or both.

The access threshold component 860 may determine that the received access metrics fail to meet an access threshold for at least one of or a plurality of the neighbor APs as described herein with reference to FIGS. 1-8A. In some cases, the access threshold component 860 may determine that the received access metrics fail to meet an access threshold for all of the neighbor APs which the association coordination component 625-b may access. In some examples, the access threshold includes an RSSI threshold or a maximum supported MCS threshold.

The indication message component 865 may transmit an indication message to at least one of the neighbor APs that at least one of the access metrics fails to meet the access threshold for at least one of the neighbor APs as described herein with reference to FIGS. 1-8A. In some examples, the indication message may be transmitted in a probe, an authentication request, an association request, or the like. In some examples, the indication message includes a required resource use value, which may include a required air time usage parameter, a required time-frequency resource usage parameter, a required throughput parameter, or the like. In some examples, the indication message includes a traffic type value indicative of a no traffic type, a with-traffic type, a real-time traffic type, or a non-real-time traffic type. In some examples, the indication message includes a network availability value indicative of whether a device may fall back to a network exclusive of the neighbor APs receiving the indication message.

The responsive message component 870 may receive a responsive message from at least one of the neighbor APs in response to the indication message as described herein with reference to FIGS. 1-8A. In some examples, a responsive message received from the neighbor APs may be responsive to the required resource use value and comprises at least one of an access denial or a suggested resource use, or both. In some cases, a responsive message received from the neighbor APs may be responsive to the traffic type value. Additionally or alternatively, a responsive message received from the neighbor APs may be responsive to the network availability value.

The neighbor association component 875 may associate with a neighbor AP based on receiving the responsive message as described herein with reference to FIGS. 1-8A.

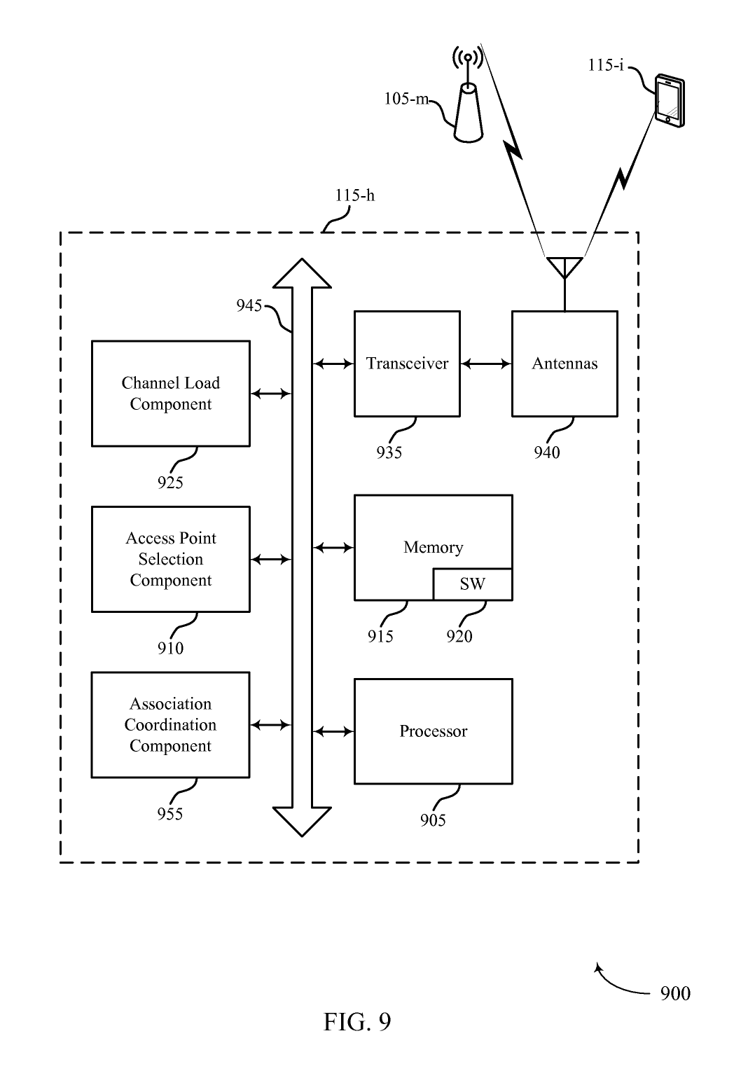

FIG. 9 illustrates a block diagram of a wireless communication system 900 for selecting an access point based on association performance in accordance with various aspects of the present disclosure. Wireless communication system 900 may include mobile device 115-h, which may be an example of a mobile device 115 described above with reference to FIGS. 1-8B. The mobile device 115-h may include an access point selection component 910, which may be an example of an access point selection component 610 described with reference to FIGS. 6A, 7A, and 8A. Mobile device 115-h may include an association coordination component 955, which may be an example of an association coordination component 625 described with reference to FIGS. 6B, 7B, and 8B. The mobile device 115-h may also include a channel load component 925. The mobile device 115-h may also include components for bi-directional voice and data communications including components for transmitting communications and components for receiving communications. For example, mobile device 115-h may communicate bi-directionally with mobile device 115-i and/or AP 105-m.

The channel load component 925 may determine a threshold for at least one channel load metric, as described above with reference to FIGS. 1-8B. The channel load component 925 may also transmit a first message comprising the threshold to an AP, as described above with reference to FIGS. 1-8B. The channel load component 925 may also receive a second message from the AP when the channel load metric of the AP satisfies the threshold, as described above with reference to FIGS. 1-8B. In some examples, the threshold limit identifies a maximum number of mobile devices permitted on a primary channel. In some examples, the first message may be a probe request and the second message is a probe response. The first message may be a probe request message and the second message may be a probe response message.

The mobile device 115-h may also include a processor component 905, memory 915 (including software (SW) 920), a transceiver component 935, and one or more antenna(s) 940, each of which may communicate, directly or indirectly, with one another (e.g., via one or more buses 945). The transceiver component 935 may communicate bi-directionally, via the antenna(s) 940 and/or wired or wireless links, with one or more networks, as described above. For example, the transceiver component 935 may communicate bi-directionally with AP 105-m and/or mobile device 115-i. The transceiver component 935 may include a modem to modulate packets and provide the modulated packets to the antenna(s) 940 for transmission, and to demodulate packets received from the antenna(s) 940. While mobile device 115-h may include a single antenna 940, mobile device 115-h may also have multiple antennas 940 capable of concurrently transmitting and/or receiving multiple wireless transmissions.

The memory 915 may include random access memory (RAM) and/or read only memory (ROM). The memory 915 may store computer-readable, computer-executable software/firmware code 920 including instructions that, when executed, cause the processor component 905 to perform various functions described herein (e.g., selecting an access point based on association performance, etc.). Alternatively, the computer-executable software/firmware code 920 may not be directly executable by the processor component 905 but cause a computer (e.g., when compiled and executed) to perform functions described herein. The processor component 905 may include an intelligent hardware device, (e.g., a central processing unit (CPU), a microcontroller, an ASIC, etc.).

Further, in one embodiment, components, for example, as shown in FIGS. 6A, 6B, 7A, 7B, 8A, 8B, and 9, may each include a circuit or circuitry for accomplishing access point selection, coordination, and/or other operations. For example, the access point selection component 610 or the association coordination component 625 may include a circuit or circuitry for transmitting an authorization request message to a target AP, receiving a delay estimation message from the target AP in response to the authorization request message, determining an estimated delay period based at least in part on information provided by the delay estimation message, transmitting a delay timing message comprising the estimated delay period to a source AP, and/or resuming traffic communication with the source AP during the estimated delay period, for example.

FIG. 10A shows a block diagram 1000 of an access point (AP) 105-n-1 configured to facilitate access point selection based on association performance in accordance with various aspects of the present disclosure. The AP 105-n-1 may illustrate aspects of APs 105 described with reference to FIGS. 1-9. The AP 105-n-1 may include a receiver 1005, an AP delay determination component 1010, and/or a transmitter 1015. The AP 105-n-1 may also include a processor. Each of these components may be in communication with one another.

The components of AP 105-n-1 may, individually or collectively, be implemented with at least one ASIC adapted to perform some or all of the applicable functions in hardware. Alternatively, the functions may be performed by one or more other processing units (or cores), on at least one IC. In other embodiments, other types of integrated circuits may be used (e.g., Structured/Platform ASICs, an FPGA, or another semi-custom IC), which may be programmed in any manner known in the art. The functions of each unit may also be implemented, in whole or in part, with instructions embodied in a memory, formatted to be executed by one or more general or application-specific processors.

The receiver 1005 may receive information such as packets, user data, and/or control information associated with various information channels 1002 (e.g., control channels, data channels, and information related to selecting an access point based on association performance, etc.). Information may be passed on to the AP delay determination component 1010 via communication link 1004, and to other components of AP 105-n-1 via communication link 1004. In some examples, the receiver 1005 may receive a request from a mobile device, the request may include an association delay threshold. In some examples, the receiver 1005 may receive a reply from a network server in response to the measurement message.

The AP delay determination component 1010 may calculate a first association delay metric for a first AP, and transmit a message comprising the first association delay metric to a mobile device via communication link 1006.

The transmitter 1015 may transmit signals 1008 received from other components of AP 105-n-1. In some embodiments, the transmitter 1015 may be collocated with the receiver 1005 in a transceiver component. The transmitter 1015 may include a single antenna, or it may include a plurality of antennas.

FIG. 10B shows a block diagram 1001 of an AP 105-n-2 that supports selecting and coordinating with an access point based on association performance in accordance with various aspects of the present disclosure. The AP 105-n-2 may illustrate aspects of APs 105 described with reference to FIGS. 1-10A. The AP 105-n-2 may include a receiver 1020, an access point association coordination component 1025, or a transmitter 1030. The AP 105-n-2 may also include a processor. Each of these components may be in communication with each other.

The components of AP 105-n-2 may, individually or collectively, be implemented with at least one ASIC adapted to perform some or all of the applicable functions in hardware. Alternatively, the functions may be performed by one or more other processing units (or cores), on at least one IC. In other examples, other types of integrated circuits may be used (e.g., Structured/Platform ASICs, an FPGA, or another semi-custom IC), which may be programmed in any manner known in the art. The functions of each unit may also be implemented, in whole or in part, with instructions embodied in a memory, formatted to be executed by one or more general or application-specific processors.

The receiver 1020 may receive information such as packets, user data, or control information associated with various information channels 1017 (e.g., control channels, data channels, and information related to association performance based AP selection, etc.). Information may be passed on to the access point association coordination component 1025 via communication link 1019, and to other components of AP 105-n-2.

The access point association coordination component 1025 may identify a time duration for contention based access to the AP 105-n-2, and transmit a link setup message that includes access priority parameters to manage access by a first set of wireless devices to the AP during the identified time duration via communication link 1021.

The transmitter 1030 may transmit signals 1023 received from other components of AP 105-n-2. In some examples, the transmitter 1030 may be collocated with the receiver 1020 in a transceiver component. The transmitter 1030 may include a single antenna, or it may include a plurality of antennas.

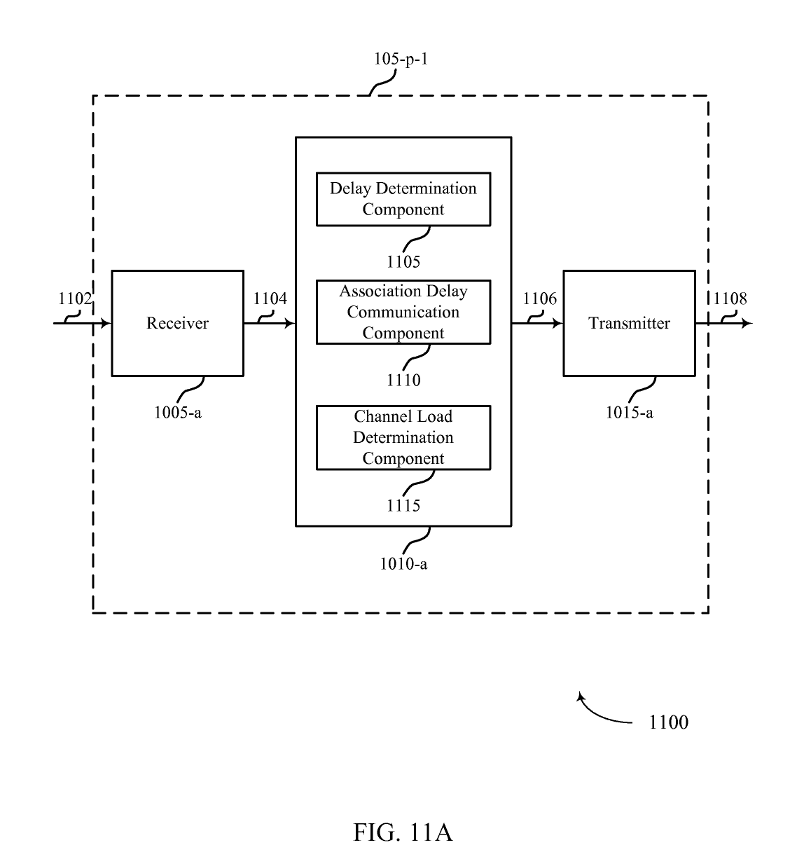

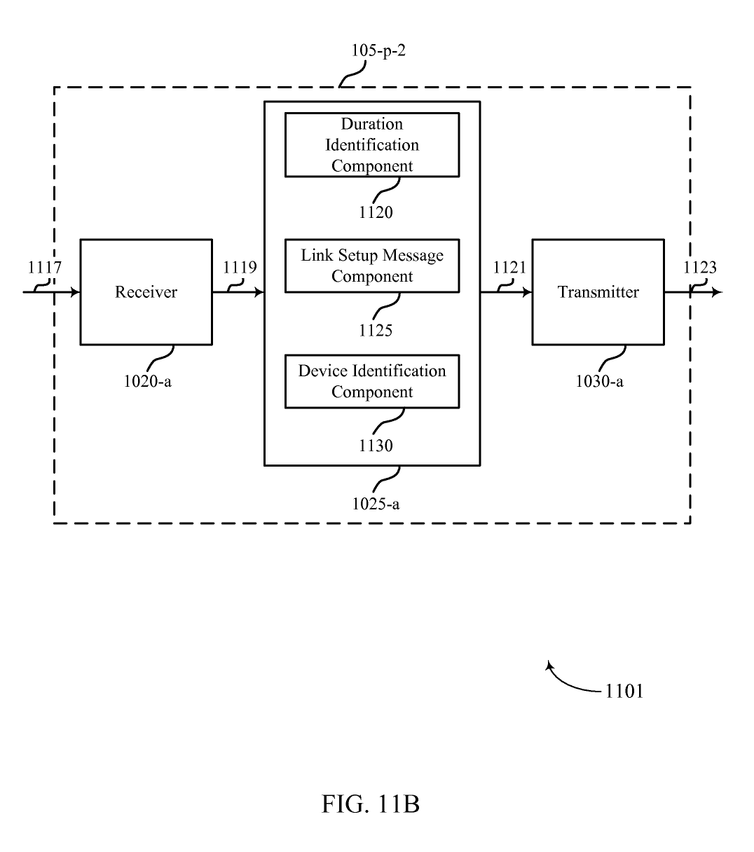

FIG. 11A shows a block diagram 1100 of an AP 105-p-1 configured to facilitate selecting an access point based on association performance in accordance with various aspects of the present disclosure. The AP 105-p-1 may illustrate aspects of APs 105 described with reference to FIGS. 1-10B. The AP 105-p-1 may include a receiver 1005-a, an AP delay determination component 1010-a, and/or a transmitter 1015-a. The AP 105-p-1 may also include a processor. Each of these components may be in communication with one another. The AP delay determination component 1010-a may also include a delay determination component 1105, an association delay communication component 1110, and a channel load determination component 1115.

The components of AP 105-p-1 may, individually or collectively, be implemented with at least one ASIC adapted to perform some or all of the applicable functions in hardware. Alternatively, the functions may be performed by one or more other processing units (or cores), on at least one IC. In other embodiments, other types of integrated circuits may be used (e.g., Structured/Platform ASICs, an FPGA, or another semi-custom IC), which may be programmed in any manner known in the art. The functions of each unit may also be implemented, in whole or in part, with instructions embodied in a memory, formatted to be executed by one or more general or application-specific processors.

The receiver 1005-a may receive information such as packets, user data, or control information associated with various information channels 1102 (e.g., control channels, data channels, and information related to selecting an access point based on association performance, etc.). Information may be passed on to the AP delay determination component 1010-a, and to other components of AP 105-p-1 via communication link 1104. The AP delay determination component 1010-a may perform the operations described above with reference to FIG. 10A and transmit messages to transmitter 1015-a via link 1106. The transmitter 1015-a may transmit signals 1108 received from other components of AP 105-p-1.

The delay determination component 1105 may calculate a first association delay metric for an AP, as described above with reference to FIGS. 1-10B. The delay determination component 1105 may also determine a second association delay metric for the AP, where the second association delay metric corresponds to a second network server, as described above with reference to FIGS. 1-10B. In some examples, the first association delay metric includes at least one of a RTD statistics between the AP and a network server or a RTD statistic between a station and a network server, or association failure rate, or combination thereof.

The association delay communication component 1110 may transmit a message including the first association delay metric to a mobile device, as described above with reference to FIGS. 1-10B. In some examples, the transmission of the message to the mobile device may be based at least in part on determining that the first association delay metric may be below the association delay threshold. The association delay communication component 1110 may also transmit the second association delay metric to the mobile device in the message, as described above with reference to FIGS. 1-10B. The association delay communication component 1110 may also transmit the second association delay metric to the mobile device, as described above with reference to FIGS. 1-10B.

The channel load determination component 1115 may receive channel metric thresholds from the mobile device. In some examples, the channel load determination component 1115 may determine the total channel load, channel load due to BSS traffic and number of associated and/or active mobile devices associated with the AP 105-p-1. In some examples, the channel load determination component 1115 may determine the channel load by measuring the primary channel associated with the AP 105-p-1 or determine the channel load based on the mobile device reports.

FIG. 11B shows a block diagram 1101 of an AP 105-p-2 that supports selecting and coordinating with an access point based on association performance in accordance with various aspects of the present disclosure. The AP 105-p-2 may illustrate aspects of APs 105 described with reference to FIGS. 1-11A. The AP 105-p-2 may include a receiver 1020-a, an access point association coordination component 1025-a, or a transmitter 1030-a. The AP 105-p-2 may also include a processor. Each of these components may be in communication with one another. The access point association coordination component 1025-a may also include a duration identification component 1120, a link setup message component 1125, and a device identification component 1130.

The components of AP 105-p-2 may, individually or collectively, be implemented with at least one ASIC adapted to perform some or all of the applicable functions in hardware. Alternatively, the functions may be performed by one or more other processing units (or cores), on at least one IC. In other examples, other types of integrated circuits may be used (e.g., Structured/Platform ASICs, an FPGA, or another semi-custom IC), which may be programmed in any manner known in the art. The functions of each unit may also be implemented, in whole or in part, with instructions embodied in a memory, formatted to be executed by one or more general or application-specific processors.

The receiver 1020-a may receive information such as packets, user data, or control information associated with various information channels 1117 (e.g., control channels, data channels, and information related to selecting an access point based on association performance, etc.). Information may be passed on to the access point association coordination component 1025-a via communication link 1119, and to other components of AP 105-p-2. The access point association coordination component 1025-a may perform the operations described above with reference to FIG. 10B and transmit messages to transmitter 1030-a via link 1121. The transmitter 1030-a may transmit signals 1123 received from other components of AP 105-p-2.

The duration identification component 1120 may identify a time duration for selecting and coordinating with an access point based on association performance as described herein with reference to FIGS. 1-11A.

The link setup message component 1125 may transmit a link setup message that includes a number of access priority parameters to manage access by a first set of wireless devices to the AP during the identified time duration as described herein with reference to FIGS. 1-11A. In some examples, the wireless devices of the first set are pre-association devices of the AP. The classification may be, for instance, a pre-association device with traffic or a pre-association device without traffic, or both. The classification may include a pre-association device with real-time traffic, a pre-association device with non-real-time traffic, or a pre-association device with no traffic, or the like. In some examples, the wireless devices of the first set include post-association devices of the AP. The link setup message component 1125 may also transmit a link setup message, which may include a plurality of access priority parameters to manage access by the set of pre-associate devices. In some examples, the classification includes a wireless device with real-time traffic, or a wireless device with non-real-time traffic, or a wireless device with no traffic, or a combination thereof. In some examples, the link setup message may include an information element, which, in turn, may include access priority parameters associated with a plurality of classifications.

The device identification component 1130 may identify a set of pre-association devices contending for access to an AP as described herein with reference to FIGS. 1-11A.

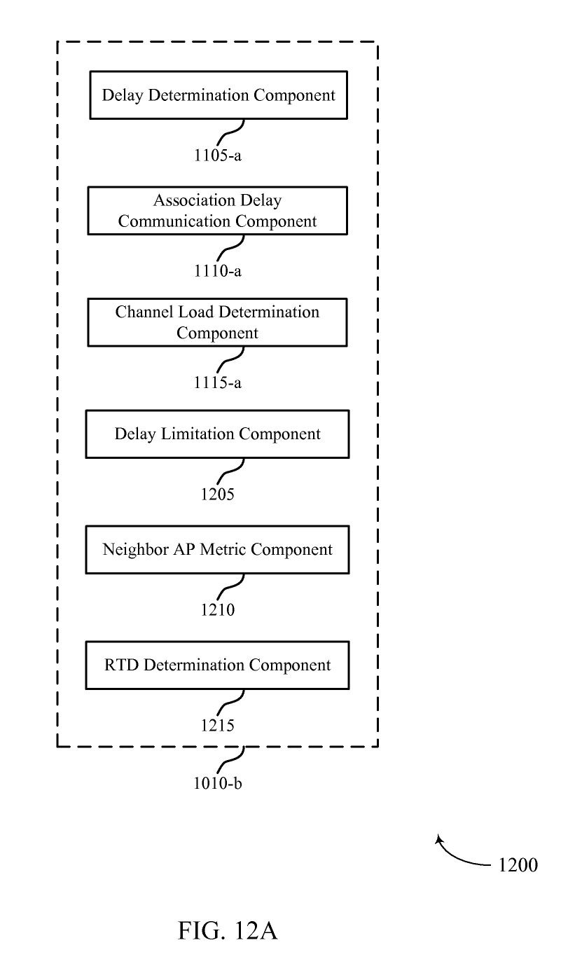

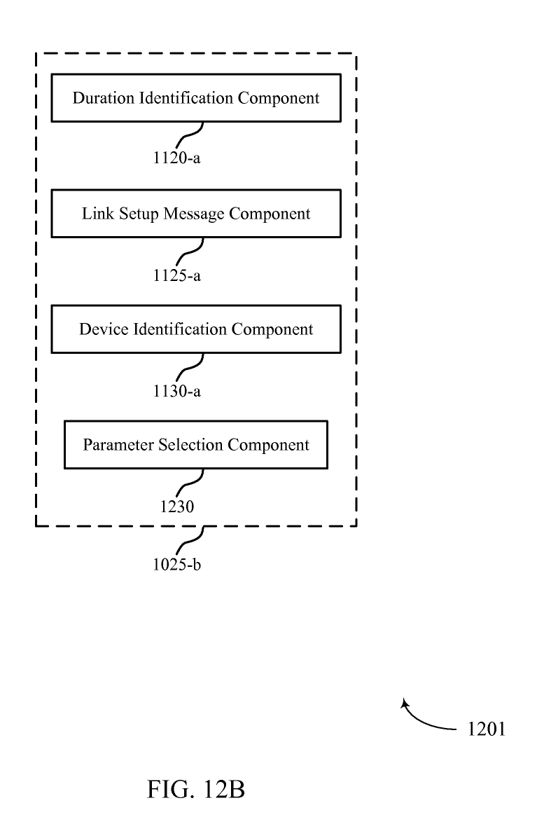

FIG. 12A shows a block diagram 1200 of an AP delay determination component 1010-b configured to facilitate selecting an access point based on association performance in accordance with various aspects of the present disclosure. The AP delay determination component 1010-b may illustrate aspects of a delay determination component 1010 described with reference to FIGS. 10A and 11A. The AP delay determination component 1010-b may include a delay determination component 1105-a, an association delay communication component 1110-a and channel load determination component 1115-a. Each of these components may perform the functions described above with reference to FIG. 11A. The delay determination component 1010-b may also include a delay limitation component 1205, a neighbor AP metric component 1210, and a RTD determination component 1215.

The components of the AP delay determination component 1010-b may, individually or collectively, be implemented with at least one ASIC adapted to perform some or all of the applicable functions in hardware. Alternatively, the functions may be performed by one or more other processing units (or cores), on at least one IC. In other embodiments, other types of integrated circuits may be used (e.g., Structured/Platform ASICs, an FPGA, or another semi-custom IC), which may be programmed in any manner known in the art. The functions of each unit may also be implemented, in whole or in part, with instructions embodied in a memory, formatted to be executed by one or more general or application-specific processors.

The delay limitation component 1205 may determine that the first association delay metric is below the association delay threshold as described above with reference to FIGS. 1-11B. In some examples, determining that the first association delay metric may be below the threshold includes transmitting a measurement message to a first network server.

The neighbor AP metric component 1210 may determine that a second association delay metric for a neighbor AP is below the association delay threshold, as described above with reference to FIGS. 1-11B.

The RTD determination component 1215 may determine a RTD statistic based on a time difference between transmitting the measurement message and receiving the reply from the first network server, as described above with reference to FIGS. 1-1 lB.

FIG. 12B shows a block diagram 1201 of an access point association coordination component 1025-b which may be a component of an AP 105 described above with reference to FIGS. 1-12A for association performance based AP selection in accordance with various aspects of the present disclosure. The access point association coordination component 1025-b may illustrate aspects of an access point association coordination component 1025 described with reference to FIGS. 10B and 11B. The access point association coordination component 1025-b may include a duration identification component 1120-a, a link setup message component 1125-a, and a device identification component 1130-a. Each of these components may perform the functions described above with reference to FIG. 11B. The access point association coordination component 1025-b may also include a parameter selection component 1230.

The components of the access point association coordination component 1025-b may, individually or collectively, be implemented with at least one ASIC adapted to perform some or all of the applicable functions in hardware. Alternatively, the functions may be performed by one or more other processing units (or cores), on at least one IC. In other examples, other types of integrated circuits may be used (e.g., Structured/Platform ASICs, an FPGA, or another semi-custom IC), which may be programmed in any manner known in the art. The functions of each unit may also be implemented, in whole or in part, with instructions embodied in a memory, formatted to be executed by one or more general or application-specific processors.

The parameter selection component 1230 may select values for the access priority parameters based at least in part on an association priority from a second set of pre-association devices of the AP during the identified time duration, such that the second set of pre-association devices may have a higher association priority than the first set of pre-association devices as described herein with reference to FIGS. 1-12A. In some examples, the access priority parameters may include an EDCA parameter, an ED threshold parameter, a PD threshold parameter, a transmit power lower or upper limit parameter, or the like. In some examples, the EDCA parameter may be an exact value or an index corresponding to an access category of a pre-association device. The access priority parameters may, in some cases, include several ED threshold parameters, and each ED threshold parameter may correspond to a different sub-channel. In some examples, the access priority parameters include subsets of access priority parameters, and each subset of access priority parameters may correspond to a classification for each pre-association device. In some cases, the parameter selection component 1230 may also select values for the access priority parameters based on a medium usage by the post-association devices, a medium usage by a set of pre-association devices, or an access category of the at least one post-association device.

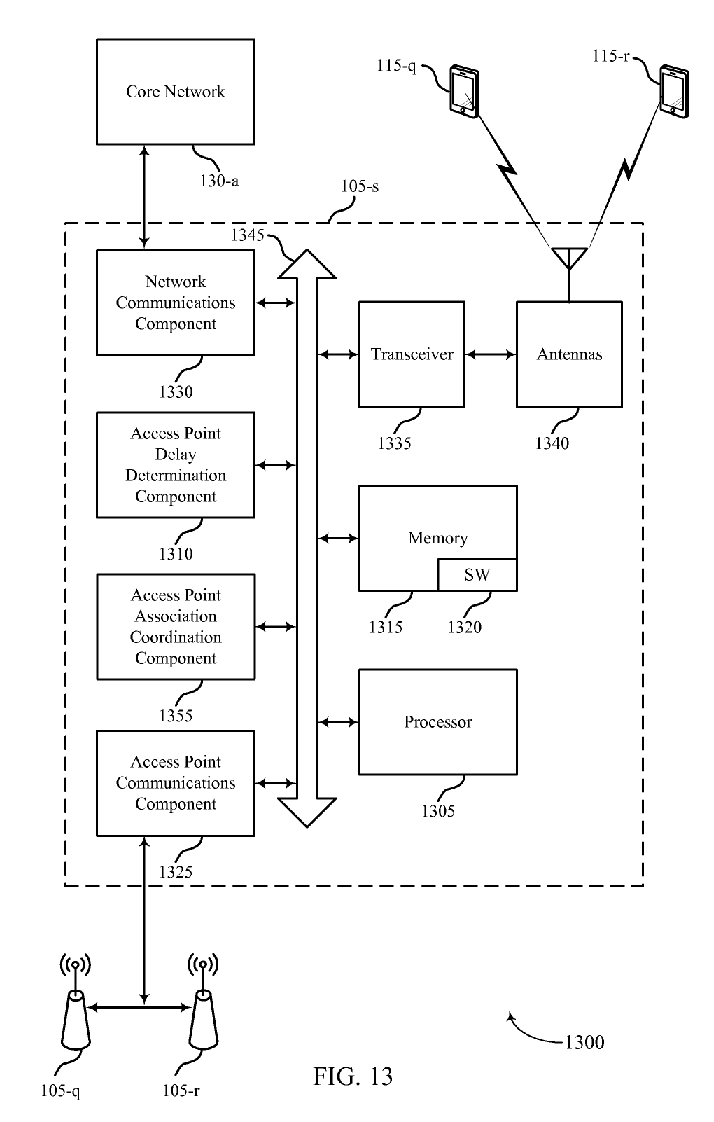

FIG. 13 illustrates a block diagram of a wireless communication system 1300 for selecting an access point based on association performance in accordance with various aspects of the present disclosure. Wireless communication system 1300 may include AP 105-s, which may be an example of APs 105 described above with reference to FIGS. 1-12B. The AP 105-s may include an access point association coordination component 1355, which may be an example of an access point association coordination component 1025 described with reference to FIGS. 10B, 11B, and 12B. The AP 105-s may include an access point delay determination component 1310, which may be an example of an AP delay determination component 1010 described with reference to FIGS. 10A, 11A, and 12A. The AP 105-s may also include components for bi-directional voice and data communications including components for transmitting communications and components for receiving communications. For example, AP 105-s may communicate bi-directionally with mobile device 115-q and/or mobile device 115-r.

In some cases, AP 105-s may have one or more wired or wireless backhaul links. AP 105-s may have a backhaul link (e.g., S1 interface, etc.) to the central node 130-a, which may be an example of central node 130 of FIG. 1. The AP 105-s may also communicate with other APs 105, such as AP 105-q and AP 105-r via inter-AP backhaul links. Each of the APs 105 may communicate with mobile devices 115 using the same or different wireless communications technologies. In some cases, AP 105-s may communicate with other APs such as 105-q and/or 105-r utilizing AP communications component 1325. In some embodiments, AP communications component 1325 may provide an X2 interface within a Long Term Evolution (LTE)/LTE-A wireless communication network technology to provide communication between some of the APs 105. In some cases, AP 105-s may communicate with the central node 130-a through network communications component 1330.

The AP 105-s may include a processor component 1305, memory 1315 (including software (SW) 1320), transceiver 1335, and antenna(s) 1340, which each may be in communication, directly or indirectly, with each other (e.g., over bus system 1345). The transceiver 1335 may be configured to communicate bi-directionally, via the antenna(s) 1340, with mobile devices 115, which may be multi-mode devices. The transceiver 1335 (and/or other components of the AP 105-s) may also be configured to communicate bi-directionally, via the antennas 1340, with one or more other APs (not shown). The transceiver 1335 may include a modem configured to modulate the packets and provide the modulated packets to the antennas 1340 for transmission, and to demodulate packets received from the antennas 1340. The AP 105-s may include multiple transceivers 1335, each with one or more associated antennas 1340. The transceiver 1335 may be an example of a combined receiver 1005 and transmitter 1015 of FIG. 10A.

The memory 1315 may include RAM and/or ROM. The memory 1315 may also store computer-readable, computer-executable software code 1320 containing instructions that are configured to, when executed, cause the processor component 1305 to perform various functions described herein (e.g., facilitating selection of an access point and a mobile device based on association performance, facilitating selection and coordination with an access point based on association performance, etc.). Alternatively, the computer-executable software code 1320 may not be directly executable by the processor component 1305 but be configured to cause the computer, e.g., when compiled and executed, to perform functions described herein. The processor component 1305 may include an intelligent hardware device, e.g., a CPU, a microcontroller, an ASIC, etc. The processor component 1305 may include various special purpose processors such as encoders, queue processing components, base band processors, radio head controllers, digital signal processors, and the like.

The AP communications component 1325 may manage communications with other APs 105. The AP communications component 1325 may include a controller and/or scheduler for controlling communications with mobile devices 115 in cooperation with other APs 105. For example, the AP communications component 1325 may coordinate scheduling for transmissions to mobile devices 115 for various interference mitigation techniques such as beam forming and/or joint transmission. Additionally or alternatively, the AP communications component 1325 may be employed to determine association delay for various APs 105 within the wireless communication system 1300.

Further, in one embodiment, components, for example, as shown in FIGS. 10A, 10B, 11A, 11B, 12A, 12B, and 13, may each include a circuit or circuitry for accomplishing access point delay determination, association coordination, and/or other operations. For example, the AP delay determination component 1010 or the access point association coordination component 1025 may include circuit or circuitry for receiving an association delay metric from at least one AP of a plurality of APs, selecting an AP of the plurality of APs for association based at least in part on the received association delay metric, and/or identifying the association delay metric based on an authentication type, for example.

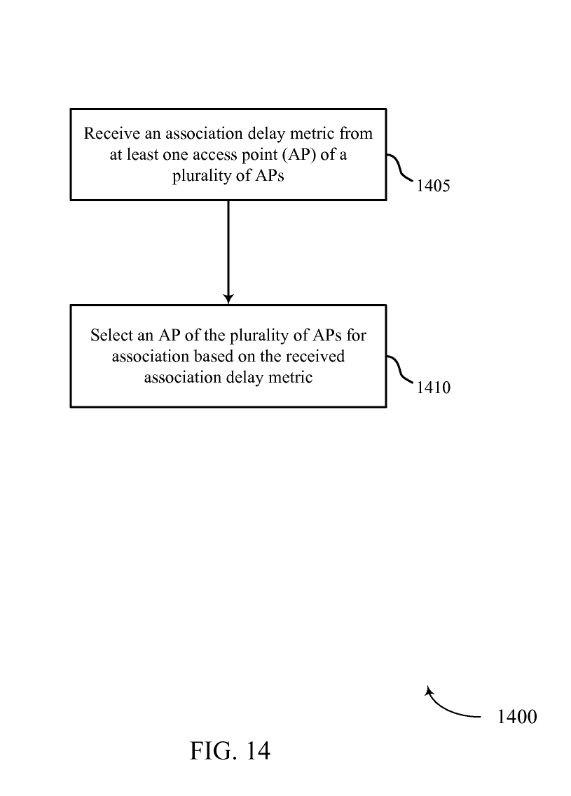

FIG. 14 shows a flowchart illustrating a method 1400 for selecting an access point based on association performance in accordance with various aspects of the present disclosure. The operations of method 1400 may be implemented by a mobile device 115 or its components, as described with reference to FIGS. 1-13. For example, the operations of method 1400 may be performed by the access point selection component 610 as described with reference to FIGS. 6-13. In some examples, a mobile device 115 may execute a set of codes to control the functional elements of the mobile device 115 to perform the functions described below. Additionally or alternatively, the mobile device 115 may perform aspects of the functions described below using special-purpose hardware.

At block 1405, the mobile device 115 may receive an association delay metric from at least one AP of a plurality of APs, as described above with reference to FIGS. 2-5. In certain examples, the operations of block 1405 may be performed by the association delay component 705, as described above with reference to FIG. 7.

At block 1410, the mobile device 115 may select an AP of the plurality of APs for association based at least in part on the received association delay metric, as described above with reference to FIGS. 2-5. In certain examples, the operations of block 1410 may be performed by the communication establishment component 710, as described above with reference to FIG. 7.

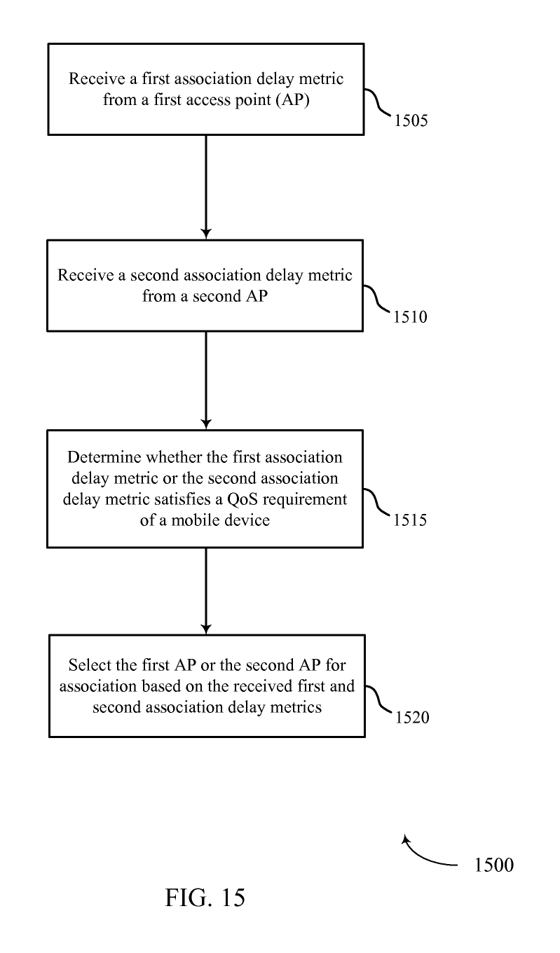

FIG. 15 shows a flowchart illustrating a method 1500 for selecting an access point based on association performance in accordance with various aspects of the present disclosure. The operations of method 1500 may be implemented by a mobile device 115 or its components as described with reference to FIGS. 1-13. For example, the operations of method 1500 may be performed by the access point selection component 610, as described with reference to FIGS. 6-13. In some examples, a mobile device 115 may execute a set of codes to control the functional elements of the mobile device 115 to perform the functions described below. Additionally or alternatively, the mobile device 115 may perform aspects of the functions described below using special-purpose hardware. The method 1500 may also incorporate aspects of method 1400 of FIG. 14.

At block 1505, the mobile device 115 may receive a first association delay metric from a first AP as described above with reference to FIGS. 2-5. In certain examples, the operations of block 1505 may be performed by the association delay component 705, as described above with reference to FIG. 7.

At block 1510, the mobile device 115 may receive a second association delay metric from a second AP as described above with reference to FIGS. 2-5. In certain examples, the operations of block 1510 may be performed by the association delay component 705, as described above with reference to FIG. 7.

At block 1515, the mobile device 115 may determine whether the first association delay metric or the second association delay metric satisfies at least one QoS requirement of a mobile device, as described above with reference to FIGS. 2-5. In certain examples, the operations of block 1515 may be performed by the QoS determination component 815 as described above with reference to FIG. 8.

At block 1520, the mobile device 115 may select the first AP or the second AP for association based at least in part on the received first and second association delay metrics, as described above with reference to FIGS. 2-5. In certain examples, the operations of block 1520 may be performed by the communication establishment component 710, as described above with reference to FIG. 7.

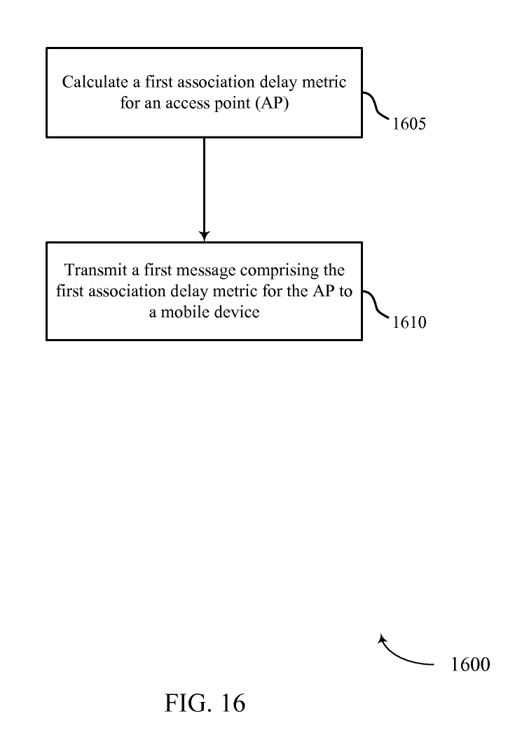

FIG. 16 shows a flowchart illustrating a method 1600 for selecting an access point based on association performance in accordance with various aspects of the present disclosure. The operations of method 1600 may be implemented by an AP 105 or its components, as described with reference to FIGS. 1-13. For example, the operations of method 1600 may be performed by the AP delay determination component 1010, as described with reference to FIGS. 10-13. In some examples, an AP 105 may execute a set of codes to control the functional elements of the AP 105 to perform the functions described below. Additionally or alternatively, the AP 105 may perform aspects of the functions described below using special-purpose hardware. The method 1600 may also incorporate aspects of methods 1400 and 1500 of FIGS. 14-15.

At block 1605, the AP 105 may calculate a first association delay metric for an AP, as described above with reference to FIGS. 2-5. In certain examples, the operations of block 1605 may be performed by the delay determination component 1105, as described above with reference to FIG. 1.

At block 1610, the AP 105 may transmit a message comprising the first association delay metric to a mobile device, as described above with reference to FIGS. 2-5. In certain examples, the operations of block 1610 may be performed by the association delay communication component 1110, as described above with reference to FIG. 1.

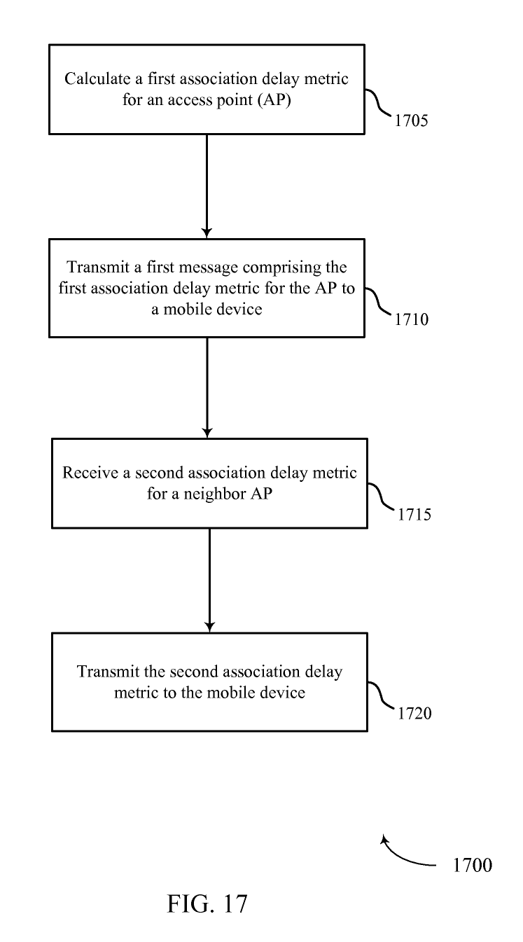

FIG. 17 shows a flowchart illustrating a method 1700 for selecting an access point based on association performance in accordance with various aspects of the present disclosure. The operations of method 1700 may be implemented by an AP 105 or its components, as described with reference to FIGS. 1-13. For example, the operations of method 1700 may be performed by the AP delay determination component 1010, as described with reference to FIGS. 10-13. In some examples, an AP 105 may execute a set of codes to control the functional elements of the AP 105 to perform the functions described below. Additionally or alternatively, the AP 105 may perform aspects of the functions described below using special-purpose hardware. The method 1700 may also incorporate aspects of methods 1400, 1500 and 1600 of FIGS. 14-16.

At block 1705, the AP 105 may calculate a first association delay metric for an AP, as described above with reference to FIGS. 2-5. In certain examples, the operations of block 1705 may be performed by the delay determination component 1105, as described above with reference to FIG. 11.

At block 1710, the AP 105 may transmit a first message comprising the first association delay metric to a mobile device, as described above with reference to FIGS. 2-5. In certain examples, the operations of block 1710 may be performed by the association delay communication component 1110, as described above with reference to FIG. 11.

At block 1715, the AP 105 may receive a second association delay metric for a neighbor AP, as described above with reference to FIGS. 2-5. In certain examples, the operations of block 1715 may be performed by the neighbor AP metric component 1210, as described above with reference to FIG. 12.

At block 1720, the AP 105 may transmit the second association delay metric to the mobile device, as described above with reference to FIGS. 2-5. In some examples, the second association delay metric associated with the neighbor AP may be transmitted with a second message. Additionally or alternatively, in some examples, the second association delay metric corresponding to the neighbor base station may be transmitted with a first message. The first message may comprise both the first association delay metric and the second association delay metric. In certain examples, the operations of block 1720 may be performed by the association delay communication component 1110, as described above with reference to FIG. 11.

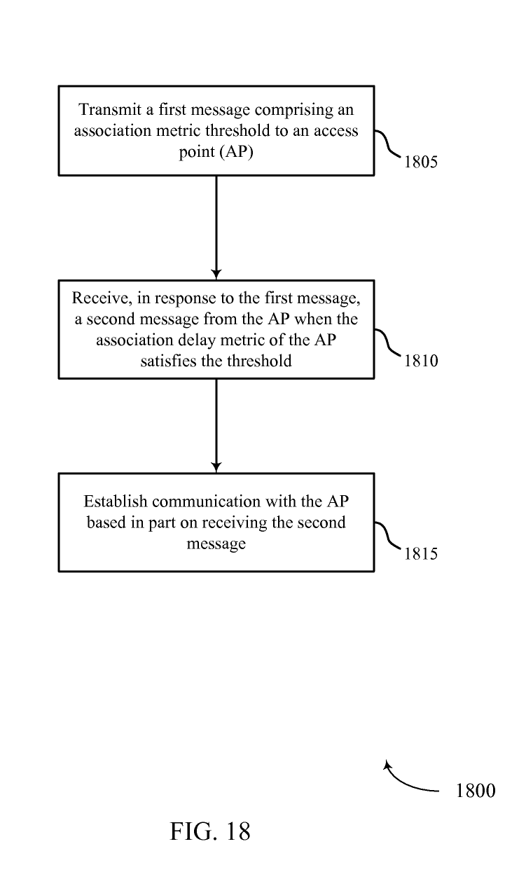

FIG. 18 shows a flowchart illustrating a method 1800 for selecting an access point based on association performance in accordance with various aspects of the present disclosure. The operations of method 1800 may be implemented by a mobile device 115 or its components as described with reference to FIGS. 1-13. For example, the operations of method 1800 may be performed by the access point selection component 610, as described with reference to FIGS. 6-13. In some examples, a mobile device 115 may execute a set of codes to control the functional elements of the mobile device 115 to perform the functions described below. Additionally or alternatively, the mobile device 115 may perform aspects of the functions described below using special-purpose hardware. The method 1800 may also incorporate aspects of method 1400, 1500, 1600 and 1700 of FIGS. 14-17.

At block 1805, the mobile device 115 may transmit a first message comprising an association metric threshold to an access point (AP) as described above with reference to FIGS. 2-5. In some examples, the association metric threshold may be transmitted using a probe request message. In certain examples, the operations of block 1805 may be performed by the threshold determination component 810, as described above with reference to FIG. 8.

At block 1810, the mobile device 115 may receive, in response to the first message, a second message from the AP when the association delay metric of the AP satisfies the threshold as described above with reference to FIGS. 2-5. In some examples, the AP may reply to the mobile device if, for instance, the mean RTD between the AP and an authentication server is less than the threshold imposed by the mobile device. In certain examples, the operations of block 1810 may be performed by the association delay component 705, as described above with reference to FIG. 7.

At block 1815, the mobile device 115 may establish communication with the AP based in part on receiving the second message, as described above with reference to FIGS. 2-5. In certain examples, the operations of block 1815 may be performed by the communication establishment component 710 as described above with reference to FIG. 8.

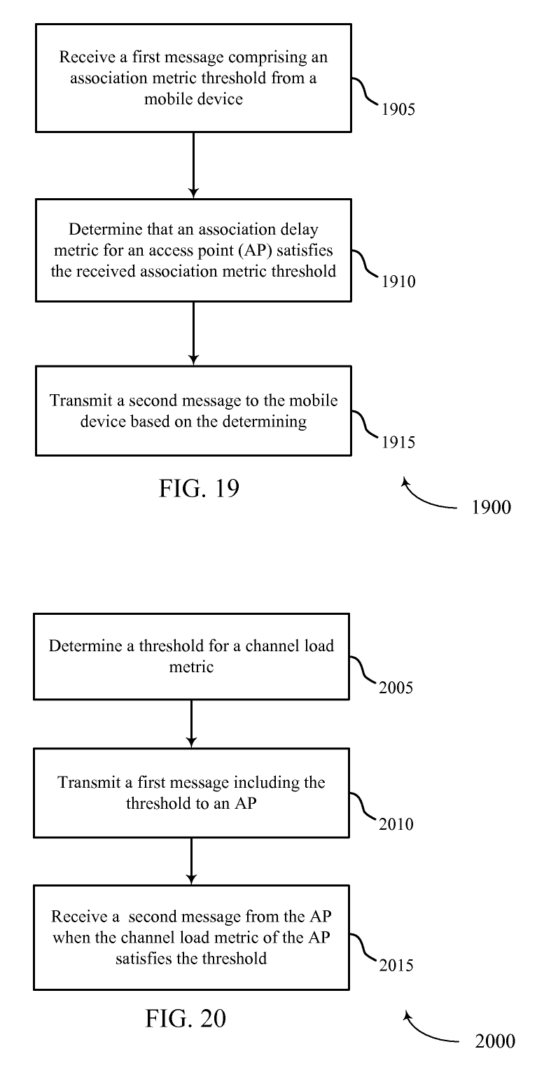

FIG. 19 shows a flowchart illustrating a method 1900 for selecting an access point based on association performance in accordance with various aspects of the present disclosure. The operations of method 1900 may be implemented by an AP 105 or its components, as described with reference to FIGS. 1-13. For example, the operations of method 1800 may be performed by the AP delay determination component 1010, as described with reference to FIGS. 10-13. In some examples, an AP 105 may execute a set of codes to control the functional elements of the AP 105 to perform the functions described below. Additionally or alternatively, the AP 105 may perform aspects of the functions described below using special-purpose hardware. The method 1800 may also incorporate aspects of methods 1400, 1500, 1600, 1700 and 1800 of FIGS. 14-18.

At block 1905, the AP 105 may receive a first message comprising an association metric threshold, as described above with reference to FIGS. 2-5. In some examples, the association metric threshold may identify limits of at least one of a RTD statistics between the AP and a network server, or a RTD statistic between a station and a network server, or an association failure rate, or combination thereof. In certain examples, the operations of block 1905 may be performed by the receiver 1005, as described above with reference to FIG. 10.

At block 1910, the AP 105 may determine that an association delay metric for the AP 105 satisfies the received association metric threshold, as described above with reference to FIGS. 2-5. In certain examples, the operations of block 1910 may be performed by the delay determination component 1105, as described above with reference to FIG. 11.

At block 1915, the AP 105 may transmit a second message to the mobile device based on the determining, as described above with reference to FIGS. 2-5. In some examples, the transmission of the second message to the mobile device is based at least in part on determining that the association delay metric of the AP is below the association metric threshold, as described above with reference to FIGS. 2-5. In certain examples, the operations of block 1915 may be performed by the association delay communication component 1110, as described above with reference to FIG. 11.

FIG. 20 shows a flowchart illustrating a method 2000 for selecting an access point based on association performance in accordance with various aspects of the present disclosure. The operations of method 2000 may be implemented by a mobile device 115 or its components, as described with reference to FIGS. 1-13. For example, the operations of method 2000 may be performed by the access point selection component 910, as described with reference to FIGS. 6-13. In some examples, a mobile device 115 may execute a set of codes to control the functional elements of the mobile device 115 to perform the functions described below. Additionally or alternatively, the mobile device 115 may perform aspects of the functions described below using special-purpose hardware. The method 2000 may also incorporate aspects of methods 1400, 1500, 1600, 1700, 1800 and 1900 of FIGS. 14-19.

At block 2005, the mobile device 115 may determine a threshold for at least one channel load metric as described above with reference to FIGS. 2-5. In certain examples, the operations of block 2005 may be performed by the channel load component 820, as described above with reference to FIG. 8.

At block 2010, the mobile device 115 may transmit a first message comprising the threshold to an AP, as described above with reference to FIGS. 2-5. In certain examples, the operations of block 1810 may be performed by the channel load component 820, as described above with reference to FIG. 8.

At block 2015, the mobile device 115 may receive a second message from the AP when the channel load metric of the AP satisfies the threshold as described above with reference to FIGS. 2-5. In certain examples, the operations of block 2015 may be performed by the channel load component 820, as described above with reference to FIG. 8.

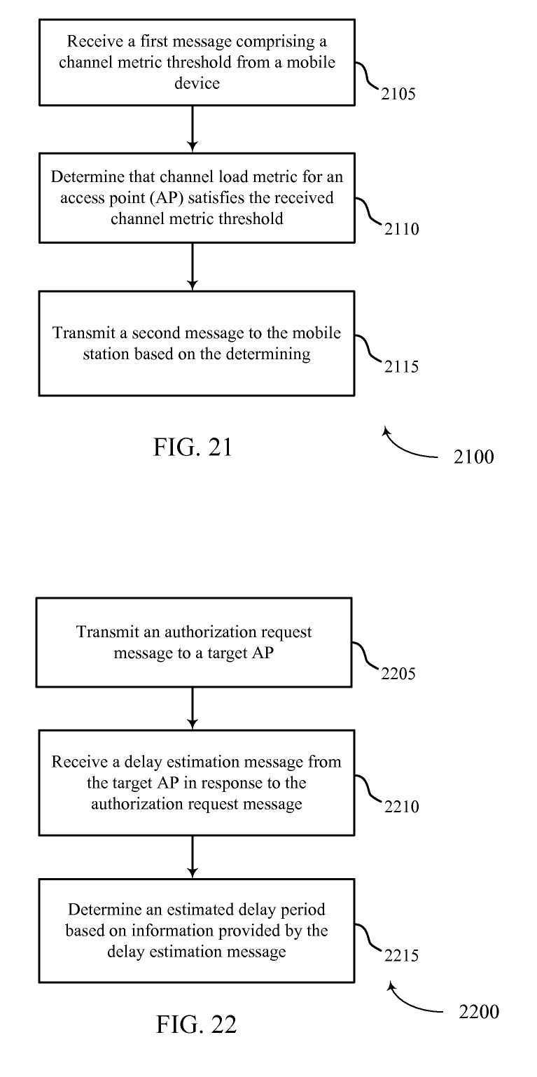

FIG. 21 shows a flowchart illustrating a method 2100 for selecting an access point based on association performance in accordance with various aspects of the present disclosure. The operations of method 2100 may be implemented by an AP 105 or its components, as described with reference to FIGS. 1-13. For example, the operations of method 2100 may be performed by the AP delay determination component 1010, as described with reference to FIGS. 10-13. In some examples, an AP 105 may execute a set of codes to control the functional elements of the AP 105 to perform the functions described below. Additionally or alternatively, the AP 105 may perform aspects of the functions described below using special-purpose hardware. The method 2100 may also incorporate aspects of methods 1400, 1500, 1600, 1700, 1800, 1900 and 2000 of FIGS. 14-20.

At block 2105, the AP 105 may receive a first message comprising a channel metric threshold from a mobile device, as described above with reference to FIGS. 2-5. In some examples, the channel metric threshold may identify a maximum number of mobile devices that may be associated with the AP. In certain examples, the operations of block 2105 may be performed by the receiver 1005, as described above with reference to FIG. 10.

At block 2110, the AP 105 may determine that the channel load metric for the AP 105 satisfies the received channel metric threshold, as described above with reference to FIGS. 2-5. In certain examples, the operations of block 2110 may be performed by the channel load determination component 1115, as described above with reference to FIG. 11.

At block 2115, the AP 105 may transmit a second message to the mobile device based on the determining, as described above with reference to FIGS. 2-5. In some examples, the transmission of the second message to the mobile device is based at least in part on determining that the channel load metric(s) of the AP are below the maximum number of mobile devices association or active with the AP, as described above with reference to FIGS. 2-5. In certain examples, the operations of block 2115 may be performed by the channel load determination component 1115, as described above with reference to FIG. 11.

Thus, methods 1400, 1500, 1600, 1700, 1800, 1900, 2000 and 2100 may provide for selecting an access point based on association performance. It should be noted that methods 1400, 1500, 1600, 1700, 1800, 1900, 2000, and 2100 describe possible implementation, and that the operations and the steps may be rearranged or otherwise modified such that other implementations are possible. In some examples, aspects from two or more of the methods 1400, 1500, 1600, 1700, 1800, 1900, 2000 and 2100 may be combined.

FIG. 22 shows a flowchart illustrating a method 2200 for association performance based AP selection in accordance with various aspects of the present disclosure. The operations of method 2200 may be implemented by a mobile device 115 or its components as described with reference to FIGS. 1-21. For example, the operations of method 2200 may be performed by the association coordination component 625 as described with reference to FIGS. 6B, 7B, and 8B. In some examples, a mobile device 115 may execute a set of codes to control the functional elements of the mobile device 115 to perform the functions described below. Additionally or alternatively, the mobile device 115 may perform aspects of the functions described below using special-purpose hardware.

At block 2205, the mobile device 115 may transmit an authorization request message to a target AP as described herein with reference to FIGS. 1-13. In certain examples, the operations of block 2205 may be performed by the authorization request message component 720 as described herein with reference to FIGS. 7B and 8B.

At block 2210, the mobile device 115 may receive a delay estimation message from the target AP in response to the authorization request message as described herein with reference to FIGS. 1-13. In certain examples, the operations of block 2210 may be performed by the delay estimation message component 725 as described herein with reference to FIGS. 7B and 8B.

At block 2215, the mobile device 115 may determine an estimated delay period based at least in part on information provided by the delay estimation message as described herein with reference to FIGS. 1-13. In certain examples, the operations of block 2215 may be performed by the delay estimator component 730 as described herein with reference to FIGS. 7B and 8B.

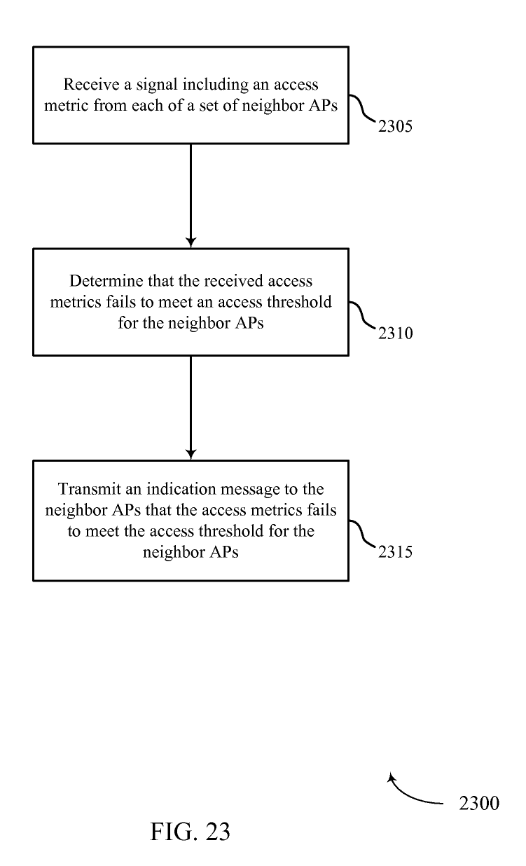

FIG. 23 shows a flowchart illustrating a method 2300 for association performance based access point selection in accordance with various aspects of the present disclosure. The operations of method 2300 may be implemented by a mobile device 115 or its components as described with reference to FIGS. 1-22. For example, the operations of method 2300 may be performed by the association coordination component 625 as described with reference to FIGS. 6B, 7B, and 8B. In some examples, a mobile device 115 may execute a set of codes to control the functional elements of the mobile device 115 to perform the functions described below. Additionally or alternatively, the mobile device 115 may perform aspects of the functions described below using special-purpose hardware. The method 2300 may also incorporate aspects of method 2200 of FIG. 22.

At block 2305, the mobile device 115 may receive a signal comprising an access metric from each of a plurality of neighbor APs as described herein with reference to FIGS. 1-13. In certain examples, the operations of block 2305 may be performed by the access metric component 855 as described herein with reference to FIG. 8B.

At block 2310, the mobile device 115 may determine that at least one of the received access metrics fails to meet an access threshold for at least one of the neighbor APs as described herein with reference to FIGS. 1-13. In certain examples, the operations of block 2310 may be performed by the access threshold component 860 as described herein with reference to FIG. 8B.

At block 2315, the mobile device 115 may transmit an indication message to at least one of the neighbor APs that at least one of the access metrics fails to meet the access threshold for at least one of the neighbor APs as described herein with reference to FIGS. 1-13. In certain examples, the operations of block 2315 may be performed by the indication message component 865 as described herein with reference to FIG. 8B.

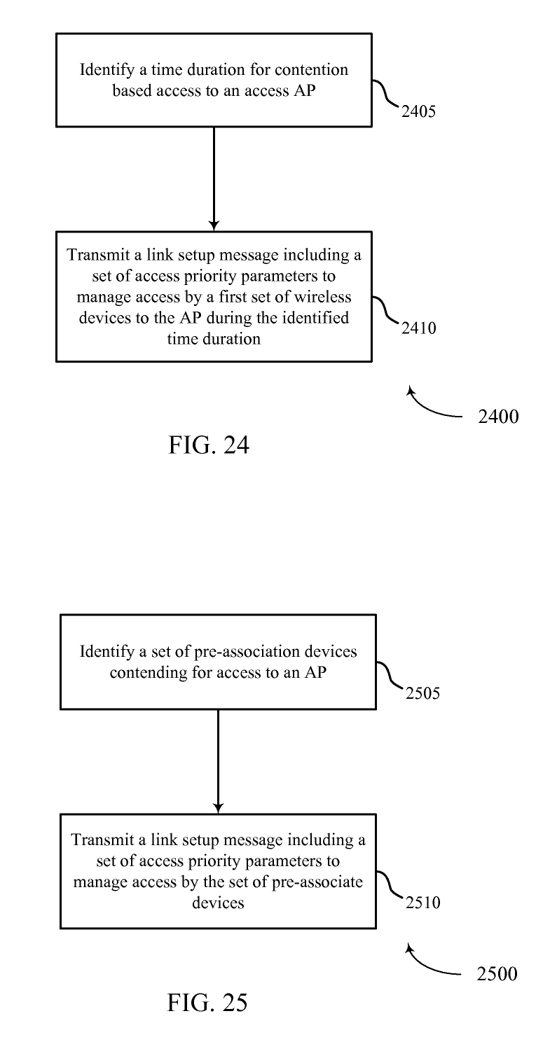

FIG. 24 shows a flowchart illustrating a method 2400 for association performance based AP selection in accordance with various aspects of the present disclosure. The operations of method 2400 may be implemented by an AP 105 or its components as described with reference to FIGS. 1-23. For example, the operations of method 2400 may be performed by the access point association coordination component 1025 as described with reference to FIGS. 10B, 11B, and 12B. In some examples, an AP 105 may execute a set of codes to control the functional elements of the AP 105 to perform the functions described below. Additionally or alternatively, the AP 105 may perform aspects of the functions described below using special-purpose hardware. The method 2400 may also incorporate aspects of methods 2200 and 2300 of FIGS. 22-23.

At block 2405, the AP 105 may identify a time duration for contention based access to an access AP as described herein with reference to FIGS. 1-13. In certain examples, the operations of block 2405 may be performed by the duration identification component 1120 as described herein with reference to FIGS. 11B and 12B.

At block 2410, the AP 105 may transmit a link setup message comprising a plurality of access priority parameters to manage access by a first set of wireless devices to the AP during the identified time duration as described herein with reference to FIGS. 1-13. In certain examples, the operations of block 2410 may be performed by the link setup message component 1125 as described herein with reference to FIGS. 11B and 12B.

FIG. 25 shows a flowchart illustrating a method 2500 for association performance based AP selection in accordance with various aspects of the present disclosure. The operations of method 2500 may be implemented by an AP 105 or its components as described with reference to FIGS. 1-24. For example, the operations of method 2500 may be performed by the access point association coordination component 1025 as described with reference to FIGS. 10B, 11B, and 12B. In some examples, an AP 105 may execute a set of codes to control the functional elements of the AP 105 to perform the functions described below. Additionally or alternatively, the AP 105 may perform aspects of the functions described below using special-purpose hardware. The method 2500 may also incorporate aspects of methods 2200, 2300, and 2400 of FIGS. 22-24.

At block 2505, the AP 105 may identify a set of pre-association devices contending for access to an AP as described herein with reference to FIGS. 1-13. In certain examples, the operations of block 2505 may be performed by the device identification component 1130 as described herein with reference to FIGS. 11B and 12B.

At block 2510, the AP 105 may transmit a link setup message comprising a plurality of access priority parameters to manage access by the set of pre-associate devices as described herein with reference to FIGS. 1-13. In certain examples, the operations of block 2510 may be performed by the link setup message component 1125 as described herein with reference to FIGS. 11B and 12B.

Thus, methods 2200, 2300, 2400, and 2500 may provide for association performance based AP selection. It should be noted that methods 2200, 2300, 2400, and 2500 describe possible implementation, and that the operations and the steps may be rearranged or otherwise modified such that other implementations are possible. In some examples, aspects from two or more of the methods 2200, 2300, 2400, and 2500 may be combined.

The detailed description set forth above in connection with the appended drawings describes example embodiments and does not represent all the embodiments that may be implemented or that are within the scope of the claims. The term “exemplary” that may be used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks, components, and modules described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, circuits, circuitry, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates a disjunctive list such that, for example, a list of [at least one of A, B, or C] means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, electrically erasable programmable read only memory (EEPROM), compact disk (CD) ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

What is claimed is:

1. A method of wireless communication, comprising:
transmitting an authorization request message to a target access point (AP);
receiving a delay estimation message from the target AP in response to the authorization request message; and
determining an estimated delay period based at least in part on information provided by the delay estimation message.

2. The method of claim 1, further comprising:
transmitting a delay timing message comprising the estimated delay period to a source AP; and
resuming traffic communication with the source AP during the estimated delay period.

3. The method of claim 2, further comprising:
determining that the estimated delay period exceeds a delay threshold, wherein the delay timing message is transmitted and the traffic communication resumed based at least in part on the estimated delay period exceeding the delay threshold.

4. The method of claim 2, further comprising:
transmitting a notification message to the source AP after determining that the estimated delay period exceeds a delay threshold; and
tuning to the target AP after transmitting the notification message or receipt of an acknowledgment of the notification message by the source AP.

5. The method of claim 2, further comprising:
tuning to the target AP after the estimated delay period; and
receiving an authentication response message from the target AP.

6. The method of claim 5, further comprising:
transmitting a polling message to the target AP after tuning to the target AP; and
receiving the authentication response message in response to the polling message.

7. The method of claim 1, further comprising:
associating the delay estimation message with at least one of an authentication server delay, a dynamic host configuration protocol (DHCP) server, a domain name system (DNS) server, or a gateway, or any combination thereof.

8. The method of claim 1, further comprising:
associating the delay estimation message with a delay estimated by the target AP based at least in part on a round-trip time of a previous message exchange.

9. A method of wireless communication, comprising:
receiving a signal comprising an access metric from each of a plurality of neighbor APs;
determining that at least one of the received access metrics fails to meet an access threshold for at least one of the neighbor APs; and
transmitting an indication message to at least one of the neighbor APs that at least one of the received access metrics fails to meet the access threshold for at least one of the neighbor APs.

10. The method of claim 9, further comprising:
receiving a responsive message from at least one of the neighbor APs in response to the indication message; and
associating with the at least one of the neighbor APs based at least in part on receiving the responsive message.

11. The method of claim 9, wherein the access metric comprises at least one of a received signal strength indication (RSSI) or a supported modulation and coding scheme (MCS).

12. The method of claim 9, wherein the access threshold comprises at least one of an RSSI threshold or a maximum supported MCS threshold.

13. The method of claim 9, further comprising:
transmitting the indication message in at least one of a probe, an authentication request, an association request, or any combination thereof.

14. The method of claim 9, wherein the indication message comprises a required resource use value comprising at least one of a required air time usage parameter, a required time-frequency resource usage parameter, a required throughput parameter, or any combination thereof.

15. The method of claim 14, wherein a responsive message received from at least one of the neighbor APs is responsive to the required resource use value and comprises at least one of an access denial or a suggested resource use, or both.

16. The method of claim 9, wherein the indication message comprises a traffic type value indicative of a least one of a no traffic type, a with traffic type, a real-time traffic type, or a non-real-time traffic type, or any combination thereof.

17. The method of claim 9, wherein the indication message comprises a network availability value indicative of whether a device may fall back to a network exclusive of at least one of the neighbor APs receiving the indication message.

18. A method of wireless communication, comprising:
receiving an association delay metric from at least one access point (AP) of a plurality of APs; and
selecting an AP of the plurality of APs for association based at least in part on the received association delay metric.

19. The method of claim 18, further comprising:
identifying the association delay metric based on an authentication type.

20. The method of claim 19, wherein the association delay metric corresponds with a plurality of authentication types, the plurality of authentication types comprising at least one of Extensible Authentication Protocol (EAP) or EAP Re-authentication Protocol (EAP-RP).

21. The method of claim 18, further comprising:
receiving, from the AP, an association delay metric for at least one neighbor AP of the plurality of APs.

22. The method of claim 18, wherein the association delay metric corresponds with a plurality of service provider networks.

23. The method of claim 18, wherein the association delay metric comprises at least one of a round-trip-delay (RTD) statistic between the AP and a network server or a RTD statistic between a station and a network server, or association failure rate, or combination thereof.

24. The method of claim 18, wherein selecting the AP of the plurality of APs comprises:
determining that the association delay metric satisfies at least one quality of service (QoS) requirement of a mobile device.

25. The method of claim 18, wherein selecting the AP of the plurality of APs comprises:
determining that the received association delay metric satisfies a predetermined metric threshold of a mobile device.

26. The method of claim 18, wherein the association delay metric is based on a response time for a measurement message between a mobile device and a network server.

27. The method of claim 18, wherein the association delay metric is based on a response time for a measurement message between the AP and a network server.

28. A method of wireless communication, comprising:
calculating a first association delay metric for an access point (AP); and
transmitting a first message comprising the first association delay metric for the AP to a mobile device.

29. The method of claim 28, further comprising:
receiving a second association delay metric for a neighbor AP; and
transmitting the second association delay metric to the mobile device.

30. The method of claim 28, wherein the first association delay metric comprises at least one of a round-trip-delay (RTD) statistic between the AP and a network server or a RTD statistic between a station and a network server, or association failure rate, or combination thereof.
